(19) United States
(12) Patent Application Publication
(10) Pub. No.: US 2022/0309561 A1
(43) Pub. Date: Sep. 29, 2022

(54) Smart Recommendations for Cycling Users

(71) Applicant: Preem, Inc., Denver, CO (US)

(72) Inventors: David Lee Norris, Denver, CO (US); Peter Brechter, Shelter Island Heights, NY (US); Austin Venhuizen, Golden, CO (US)

(21) Appl. No.: 17/705,181

(22) Filed: Mar. 25, 2022

Related U.S. Application Data
(60) Provisional application No. 63/166,911, filed on Mar. 26, 2021.

(51) Int. Cl. G06Q 30/06

(52) U.S. Cl. CPC G06Q 30/0631

(57) ABSTRACT

In one embodiment, a cycling data platform may receive data corresponding to a cycling ride of a first user including one or more ride parameters. The cycling data platform may access a user profile of the first user comprising a cycling profile of the first user, where the cycling profile indicates one or more characteristics of cycling habits of the first user. The cycling data platform may update the cycling profile of the first user based on the one or more ride parameters. The cycling data platform may generate, using a recommendation engine, one or more recommendations for the first user based on the cycling profile of the first user.

### PRIORITY

This application claims the benefit, under 35 U.S.C. § 119(e), of U.S. Provisional Patent Application No. 63/166,911, filed 26 Mar. 2021, which is incorporated herein by reference.

### TECHNICAL FIELD

This disclosure generally relates to a data management system, and in particular, a data management system for cycling data.

### BACKGROUND

Users who are interested in cycling may need to continually purchase products for their cycling activities. Currently, users may purchase products from various websites based on reviews and price of the product. These users may sometimes use a subscription plan from a website to periodically purchase a product, such as purchasing a product every month. However, a user may not necessarily need a particular cycling product every month so the user may need to update a subscription plan or wait to receive the desired product. Different users may have different needs and may consume products differently.

### BRIEF DESCRIPTION OF THE DRAWINGS

FIG. 1 illustrates an example network environment associated with a cycling data platform.

FIG. 2 illustrates an example environment of a cycling data platform.

FIG. 3 illustrates an example flow diagram of a notification process of a cycling data platform.

FIG. 4 illustrates another example flow diagram of a notification process of a cycling data platform.

FIG. 5 illustrates an example user interface of a website including a subscription service.

FIGS. 6A-6D illustrate example user interfaces for creating a cycling profile associated with a cycling data platform.

FIGS. 7A-7B illustrate example user interfaces for importing cycling data onto a cycling data platform.

FIGS. 8A-8B illustrate example user interfaces of a cycling profile associated with a cycling data platform.

FIG. 9 illustrates an example user interface of a match score on a cycling profile associated with a cycling data platform.

FIGS. 10A-10D illustrate example user interfaces of recommendations for a user.

FIG. 11 illustrates an example user interface of a home screen associated with a cycling data platform.

FIG. 12 illustrates an example user interface of a newsfeed associated with a cycling data platform.

FIGS. 13A-13C illustrate example user interfaces of weather recommendations associated with a cycling data platform.

FIGS. 14A-14C illustrate example user interfaces of consumable recommendations associated with a cycling data platform.

FIG. 15 illustrates an example method of generating a recommendation associated with a cycling data platform.

FIG. 16 illustrates an example computer system.

### DESCRIPTION OF EXAMPLE EMBODIMENTS

### Smart Recommendations System Overview

As the cycling industry grows, there will be more cyclists on the road. A number of cyclists may congregate weekly or sub-weekly to cycle with one another. All of these cyclists will ride their bicycles on an either planned or unplanned route. Cyclists may choose to cycle or not cycle on specific days due to weather and environmental conditions. Each of the cyclists may need to continually maintain their bikes. Additionally, cyclists may purchase consumables, such as supplements, gels and the like. Historically, cyclists may use a combination of websites, word-of-mouth, interpersonal networks, and volunteered local knowledge to identify social cycling gatherings, cyclists to ride with, and routes to complete. To improve upon the cycling experience, there may be a cycling data platform that recommends social rides a user may attend, partners to ride with, and routes to ride. For instance, as the user rides his or her bike data can be sent to the cycling data platform to be used to determine when to send notifications to a user to try a route, such as a road route, an off-road route, and the like. Historically, cyclists may use a combination of weather apps, online communities, and messaging services to determine what days they will ride their bicycle either in isolation or with other cyclists. To improve upon the cycling experience, there may be a cycling data platform that recommends the best days to ride a bicycle outdoors, which rides to attend, days to avoid riding outdoors, and notifies riders of hazardous weather conditions throughout a ride. For instance, as the user creates a plan to ride their bicycle at a future date, environmental data can be sent to the cycling data platform to be used to determine when to send notifications to a user to modify their cycling plans due to reschedule a ride, modify a route, and the like to compensate for changes in environmental conditions. Historically, cyclists may purchase cycling products based on the price of the products. To improve upon the cycling experience, there may be a cycling data platform that monitors when the user may need to purchase cycling products. For instance, as the user rides his or her bike data can be sent to the cycling data platform to be used to determine when to send notifications to purchase cycling products, such as a replacement tire, more consumables, and the like. To do so, the cycling data platform may request data from the user, such as access to monitoring data corresponding to a bike of the user. The cycling data platform may use a recommendations model to determine when the user may need additional cycling products. Additionally, the cycling data platform may use a recommendations model to generate a user profile of the user. The user profile may be a comprehensive cycling profile of the user to indicate one or more characteristics of a user's cycling habits. The cycling data platform may access the user profile to identify content related to cycling the user may be interested in watching. As an example and not by way of limitation, the cycling data platform may determine that the user may need to perform bike maintenance on his or her bike and identify a video about bike maintenance the user would be interested in watching. More specifically, the user profile may contain one or more bike models corresponding to the bikes owned by the user. The video about bike maintenance may be specific to a particular bike model owned by the user. The cycling data platform may send a notification linking to the user corresponding to the video. While previous subscription services may simply routinely suggest purchasing an item, such as on a monthly schedule, the cycling data platform is able to identify a more precise time of when a product may need to be purchased. Thereby, reducing unnecessary frustrations for the user to change any purchasing settings. This may improve on the experience of the user by creating an interface where the user will need to minimally interact with in order to purchase the desired items. That is, the user will not have to continually monitor monthly subscriptions that the user may not need and alter the subscriptions to delay or remove the item in question. By focusing on certain products, certain data may be used to identify an optimal time for a user to repurchase products. For instance, if a user consumes a sports drink during each workout and works out three days a week, the cycling data platform may determine an optimal time to repurchase the desired sports drink to ensure the user does not run out. The user may then be notified and purchase the item in response to receiving a notification from the cycling data platform.

In particular embodiments, a cycling data platform may receive data corresponding to a cycling ride of a first user. The data corresponding to the cycling ride may comprise one or more ride parameters. In particular embodiments, the one or more ride parameters can comprise one or more route characteristics. As an example and not by way of limitation, the route characteristics can indicate the weather for the route, whether the route is on road, gravel, dirt, etc., distance of the route, and the like. In particular embodiments, the data corresponding to the cycling ride may be received from one or more of a monitoring device or a client system of the first user. As an example and not by way of limitation, the monitoring device may be a device attached to a bike to record speed, distance, and the like. The first user may also wear a monitoring device to monitor calories burned and the like. The client system can be a smartphone associated with the first user. The client system can connect to a device (e.g., monitoring device) and access the data to upload to the cycling data platform. Although this disclosure describes receiving data corresponding to a cycling ride in a certain manner, the disclosure contemplates receiving data corresponding to a cycling ride in any suitable manner.

In particular embodiments, the cycling data platform may access a user profile of the first user. The user profile can comprise a cycling profile of the first user. In particular embodiments, the cycling profile can indicate one or more characteristics of cycling habits of the first user. In particular embodiments, the cycling habits of the first user can be indicative of one or more previous cycling routes taken by the first user. In particular embodiments, the cycling data platform can store the user profiles of users in a database associated with the cycling data platform to access later. Although this disclosure describes accessing a user profile in a particular manner, the disclosure contemplates accessing a user profile in any suitable manner.

In particular embodiments, the cycling data platform may update the cycling profile of the first user. In particular embodiments, the cycling data platform may update the cycling profile of the first user based on the one or more ride parameters. As an example and not by way of limitation, if the first user performed a ride that include specific route characteristics, such as 30 miles long, average 25 mph, and sunny weather, and road, then the cycling data platform can update the cycling profile to include the data corresponding to the ride. The update may associate one or more tags to the cycling profile of the first user. Although this disclosure describes updating a cycling profile in a particular manner, the disclosure contemplates updating a cycling profile in any suitable manner.

In particular embodiments, the cycling data platform may generate one or more recommendations for the first user. In particular embodiments, the cycling data platform may use a recommendations engine to generate the one or more recommendations for the first user based on the cycling profile of the first user. As described herein, the cycling data platform can calculate a match score between the first user and another entity (e.g., another user, a circle, a route, a group ride, content, and the like). The cycling data platform may use the recommendations engine to calculate the match score. In particular embodiments, the one or more recommendations can comprise one or more of content to be viewed by the first user, a product (e.g., a consumable) for the first user to purchase, a second user to make a connection, a group to join, or a route for the first user to ride. In particular embodiments, the recommendations engine can comprise one or more of a machine-learning model, simple rules engine, or a matching engine. In particular embodiments, the cycling data platform can generate a notification of the one or more recommendations to send to a client system associated with the first user. The cycling data platform can send instructions to the client system of the first user to present the notification. Although this disclosure describes generating one or more recommendations in a particular manner, the disclosure contemplates generating one or more recommendations in any suitable manner.

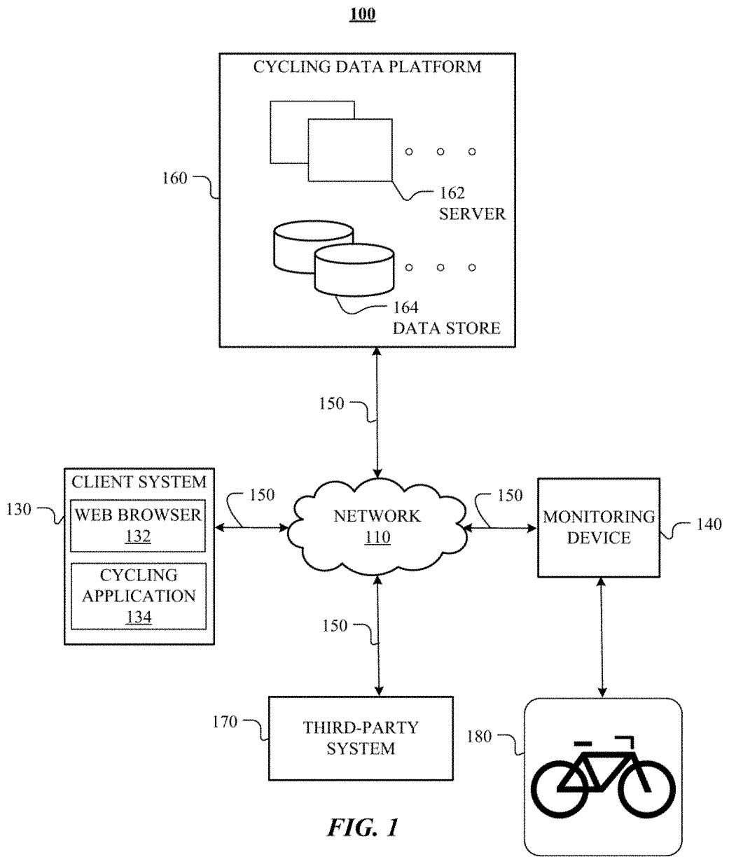

FIG. 1 illustrates an example network environment 100 associated with a cycling data platform. Network environment 100 may include a client system 130, a cycling data platform 160, a third-party system 170, a monitoring device 140, and a bicycle 180 connected to each other by a network 110. Although FIG. 1 illustrates a particular arrangement of client system 130, cycling data platform 160, third-party system 170, monitoring device 140, bicycle 180 and network 110, this disclosure contemplates any suitable arrangement of client system 130, cycling data platform 160, third-party system 170, monitoring device 140, bicycle 180 and network 110. As an example and not by way of limitation, two or more of client system 130, cycling data platform 160, third-party system 170, monitoring device 140, and bicycle 180 may be connected to each other directly, bypassing network 110. As another example, two or more of client system 130, cycling data platform 160, third-party system 170, monitoring device 140, and bicycle 180 may be physically or logically co-located with each other in whole or in part. Moreover, although FIG. 1 illustrates a particular number of client systems 130, cycling data platforms 160, third-party systems 170, monitoring devices 140, and bicycles 180, and networks 110, this disclosure contemplates any suitable number of client systems 130, cycling data platforms 160, third-party systems 170, monitoring devices 140, bicycles 180, and networks 110. As an example and not by way of limitation, network environment 100 may include multiple client systems 130, cycling data platforms 160, third-party systems 170, monitoring devices 140, bicycles 180, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, cycling data platform 160, third-party system 170, and monitoring device 140 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132 and may have one or more add-ons, plug-ins, or other extensions. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, client system 130 may include a cycling application 134. A user at client system 130 may download the cycling application 134. As an example and not by way of limitation, the cycling application 134 may be downloaded from an app store. In particular embodiments, the cycling application 134 may be associated with the cycling data platform 160. In particular embodiments, a user may access data, content, etc. from the cycling data platform 160 via cycling application 134 executed on the client system 130. As an example and not by way of limitation, the user may purchase products via the cycling data platform 160 or watch a video stored on the cycling data platform 160 by using the cycling application 134 on the client system 134.

In particular embodiments, cycling data platform 160 may be a network-addressable computing system that can host a smart recommendations service. The cycling data platform 160 may monitor data received from users to generate recommendations for users. The cycling data platform 160 may receive suitable approval from users (e.g., subject to user privacy settings) to monitor the users' data to generate personalized content and recommendations for the users. In particular embodiments, the cycling data platform 160 may use a recommendations engine in order to generate recommendations for users including content to watch and products for the user to buy. As an example and not by way of limitation, the cycling data platform 160 may use a recommendations engine to identify content the user may find interesting. For instance, the recommendations engine may receive a plurality of data to analyze to identify particular content the user may be interested in watching. To do so, the recommendations engine may collect data from various sources (e.g., user's ride data, third-party data) upon approval from user and generate a user profile of the user. The user profile may comprise one or more characteristics of a cycling profile of the user, such as a type of cyclist, brands the user likes, and the like. The recommendations engine can comprise one or more of a machine-learning model, a simple rules engine, or a matching engine. As an example and not by way of limitation, a recommendations engine can use a machine-learning model to process data to generate a recommendation. As another example and not by way of limitation, the recommendations engine can use a rules engine that determines to send particular bicycle maintenance videos (replacing a bicycle tire) when the user is recommended a replacement part. As another example and not by way of limitation, the recommendations engine can use a matching engine to match tags associated with a product and a user to recommend the product to the user (e.g., both of the product and the user have the tag “road cycling”). The cycling data platform 160 may determine that the user may need to perform maintenance on their bicycle 180, which could be a bicycle. After making the determination, the cycling data platform 160 may identify bicycle maintenance videos to present to the user to watch. In particular embodiments, the cycling data platform 160 may generate recommendations for the users. As an example and not by way of limitation, the cycling data platform 160 may use a recommendations engine to monitor when a user would need a replacement part for his or her bicycle 180. For example, the recommendations engine may receive riding data corresponding to the bicycle 180 and determine when a part may need to be replaced. In particular embodiments, the cycling data platform 160 may generate, store, receive, and send content generated by users that are a part of the network of the cycling data platform 160 (e.g., users to the cycling data platform 160). Cycling data platform 160 may be accessed by the other components of network environment 100 either directly or via network 110. In particular embodiments, cycling data platform 160 may receive inputs from one or more of the client system 130, third-party system 170, monitoring device 140, or bicycle 180. The cycling data platform 160 may apply the recommendations engine to the received inputs in order to generate recommendations for the user. In particular embodiments, cycling data platform 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, cycling data platform 164 may include one or more data stores 164. Data stores 164 may be used to store various types of information. As an example and not by way of limitation, the data stores 164 may store content generated by users to be shared. For example, the content may be cycling videos. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a cycling data platform 160, or a third-party system 170 to manage, retrieve, modify, add, or delete, the information stored in data store 164.

In particular embodiments, cycling data platform 160 may be capable of linking a variety of entities. As an example and not by way of limitation, cycling data platform 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating cycling data platform 160. In particular embodiments, however, cycling data platform 160 and third-party systems 170 may operate in conjunction with each other to provide search engine services to users of cycling data platform 160 or third-party systems 170. In this sense, cycling data platform 160 may provide a platform, or backbone, which other systems, such as third-party systems 170, may use to provide search engine services and functionality to users across the Internet.

In particular embodiments, cycling data platform 160 also includes user-generated content objects, which may enhance a user's interactions with cycling data platform 160. User-generated content may include anything a user can add, upload, send, or “post” to cycling data platform 160. In particular embodiments, user-generated content may comprise user-profile information. As an example and not by way of limitation, a user communicates posts to cycling data platform 160 from a client system 130. Posts may include content such as cycling videos, other textual data, location information, photos, videos, links, or other similar data or content. Content may also be added to cycling data platform 160 by a third-party (for example, from social media websites, merchant website, etc.) through a suitable communication channel.

In particular embodiments, cycling data platform 160 may include a variety of servers, sub-systems, programs, modules, logs, and data stores. In particular embodiments, cycling data platform 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user/patient-profile store, connection store, third-party content store, or location store. Cycling data platform 160 may also include suitable components such as network interfaces, security mechanisms, load balancers, failover servers, management-and-network-operations consoles, other suitable components, or any suitable combination thereof. In particular embodiments, cycling data platform 160 may include one or more user-profile stores for storing user profiles. A user profile may include, for example, a list of cycling equipment, physiologic information, brand preferences, biographic information, demographic information, behavioral information, social information, or other types of descriptive information, such as work experience, educational history, hobbies or preferences, interests, affinities, or location. The user profile may also include a cycling profile of the user. While several components of the cycling profile may be discussed as separate from the user profile, the user profile may include all the information of the cycling profile. The cycling profile may indicate one or more characteristics of cycling habits of the user. The cycling profile may include a type of cyclist, which may indicate what kind of rides the user likes, how fast does the user ride, what type of terrain the user rides on, what routes the user rides on, what weather the user rides in, how often the user rides, and other information corresponding to cycling characteristics of the user. In particular embodiments, the cycling profile of a user may share the same characteristics of a cycling profile of another user. As such, successful recommendations, such as watched content or highly-rated products (by the user) may be recorded and associated with the certain cycling profile. As an example and not by way of limitation, if a cycling profile indicating a rider who likes off-road routes watches certain mountain bike videos, the cycling data platform 160 may record an association with an off-road cycling profile with videos pertaining to mountain bikes. A web server may be used for linking cycling data platform 160 to one or more client systems 130 or one or more third-party system 170 via network 110. The web server may include a mail server or other messaging functionality for receiving and routing messages between cycling data platform 160 and one or more client systems 130. An API-request server may allow a third-party system 170 to access information from cycling data platform 160 by calling one or more APIs. An action logger may be used to receive communications from a web server about a user's actions on or off cycling data platform 160. In conjunction with the action log, a third-party-content-object log may be maintained of user exposures to third-party-content objects. A notification controller may provide information regarding content objects to a client system 130. Information may be pushed to a client system 130 as notifications (or reminders), or information may be pulled from client system 130 responsive to a request received from client system 130. Authorization servers may be used to enforce one or more privacy settings of the users of cycling data platform 160. A privacy setting of a user determines how particular information associated with a user can be shared. The authorization server may allow users to opt in to or opt out of having their actions logged by cycling data platform 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users.

In particular embodiments, monitoring device 140 may be an electronic device including hardware, software, or embedded logic components or a combination of two or more such components and capable of carrying out the appropriate functionalities implemented or supported by monitoring device 140. As an example and not by way of limitation, a monitoring device 140 may include a computer system such as a wearable device, a smartwatch, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable monitoring device 140. A monitoring device 140 may enable a network user at monitoring device 140 to access network 110. In particular embodiments, the monitoring device 140 may be embodied as the client system 130. As an example and not by way of limitation, the monitoring device 140 and client system 130 may be the same device. In particular embodiments, the monitoring device 140 may be coupled to the bicycle 180. In particular embodiments, the monitoring device 140 may be wirelessly coupled to the bicycle 180. This disclosure contemplates any suitable wireless connection. In particular embodiments, the monitoring device 140 may be wirelessly coupled to the bicycle 180 through one of an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, or a combination of two or more such connections. In particular embodiments, the connection between the monitoring device 140 and the bicycle 180 may be a physical coupling of the monitoring device 140 to the bicycle 180. In particular embodiments, the monitoring device 140 may track data corresponding to the bicycle 180. As an example and not by way of limitation, the monitoring device 140 may track ride data corresponding to the bicycle 180. For example, the monitoring device 140 may track the distance traveled, total time for the ride, and the like for the bicycle 180. In particular embodiments, the monitoring device 140 may track the data of the user that is riding the bicycle 180. As an example and not by way of limitation, the monitoring device 140 may track the heart rate of the user while the user is riding the bicycle 180. In particular embodiments, the monitoring device 140 may be embodied as two separate devices that one tracks the user and the other tracks the bicycle 180. In particular embodiments, the bicycle 180 may be a road bike, mountain bike, hybrid bike, electric bike, and the like. In particular embodiments, the monitoring device 140 may continually send data to the cycling data platform 160 or only send data when a ride is concluded. In particular embodiments, the monitoring device 140 may be coupled with the bicycle 180. As an example and not by way of limitation, the bicycle 180 may include the monitoring device 140. In particular embodiments, the data gathered by the monitoring device 140 may be in a format that the cycling data platform 160 may analyze. As an example and not by way of limitation, the data may be in the form of a geography information system (GIS) data file.

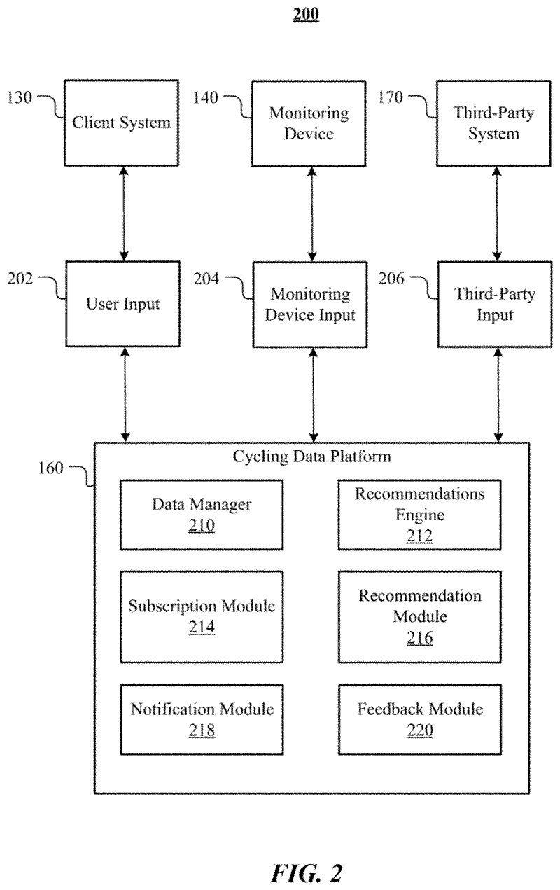

FIG. 2 illustrates an example environment 200 of a cycling data platform 160. The environment 200 may include a client system 130, monitoring device 140, third-party system 170, user input 202, a monitoring device input 204, third-party input 206, and a cycling data platform 160. Although FIG. 2 illustrates a particular arrangement of a client system 130, monitoring device 140, third-party system 170, user input 202, a monitoring device input 204, third-party input 206, and cycling data platform 160, this disclosure contemplates any suitable arrangement of the client system 130, monitoring device 140, third-party system 170, user input 202, monitoring device input 204, and a cycling data platform 160. Moreover, although FIG. 2 illustrates a particular number of client systems 130, monitoring devices 140, third-party systems 170, user inputs 202, monitoring device inputs 204, third-party inputs 206, and cycling data platforms 160, this disclosure contemplates any suitable number of client systems 130, monitoring devices 140, third-party systems 170, user inputs 202, monitoring device inputs 204, third-party inputs 206, and cycling data platforms 160.

In particular embodiments, the user input 202 may be received from a client system 130 of a user. As an example and not by way of limitation, the user input 202 may be received within an application interface that is executed on a client system 130, such as a smartphone. As another example and not by way of limitation, the user input 202 may be received within a website interface that is executed on a client system 130. In particular embodiments, client system 130 may send the data corresponding to the user input 202 when it receives the user input 202 from the user. In particular embodiments, the user input 202 may be received from another computing system. In particular embodiments, the user input 202 may include one or more of an age, gender, home address, social network, interests, frequency of rides, favorite brands of products (e.g., cycling products), and other information corresponding to a user's cycling behavior. In particular embodiments, the client system 130 may initially request user input 202 from the user when setting up a user profile corresponding to an application and/or the cycling data platform 160. The user input 202 may be updated when necessary (either automatically or manually), such as if the user moves to a new location. In particular embodiments, the user input 202 may include equipment the user has that may need to be maintained. As an example and not by way of limitation, the user may specify with the user input 202 that the user rides a 2015 road bike with newly replaced wheels. Further details may be included, such as brand of bike and/or tires that are currently used on the bike. In particular embodiments, the user may include events that the user is participating in with the user input 202, clubs joined, and/or teams joined. In particular embodiments, the user input 202 may include a social network of a user. The user may identify one or more other users that are associated with the user's social network. The user may be associated with an account of a social network, which may be linked to the cycling data platform 160. As an example and not by way of limitation, the user may sign into his or her account within an application associated with the cycling data platform 160, which may link their social network account with the cycling data platform 160. In particular embodiments, the user input 202 may be sent to the cycling data platform 160. The user input 202 may be automatically pushed to the cycling data platform 160 or the user input 202 may be stored (e.g., in a data store of a client system 130) until it is requested by the cycling data platform 160.

In particular embodiments, the monitoring device input 204 may be data corresponding to a user performing an activity, such as when the user is cycling. In particular embodiments, the monitoring device input 204 may be received from a monitoring device 204. In particular embodiments, the monitoring device input 204 may be received from a monitoring device 140 coupled to a bicycle. As an example and not by way of limitation, the monitoring device 140 may be coupled to a road bike. As another example and not by way of limitation, the user may carry (e.g., wearing) the monitoring device 140 while performing an activity (e.g., cycling). The monitoring device 140 may send the monitoring device input 204 collected as it collects the data to the cycling data platform 160 or the monitoring device 140 may send the monitoring device input 204 to the cycling data platform 160 after the conclusion of the activity. In particular embodiments, the monitoring device 140 may send the monitoring device input 204 to the cycling data platform 160 after connecting to a wireless network. In particular embodiments, the monitoring device 140 may send the monitoring device input 204 to the client system 130 to send to the cycling data platform 160. As an example and not by way of limitation, a cycling application 134 may request and access monitoring device input 204 from the monitoring device 140 either during an activity, conclusion of an activity, or periodically. In particular embodiments, the monitoring device 140 may be embodied as two or more separate devices to collect monitoring device input 204 corresponding to an activity. As an example and not by way of limitation, the monitoring device 140 may be embodied as a fitness tracker and a cycling attachment to monitor cycling activity of the user. In particular embodiments, the monitoring device input 204 may include one or more of a heart rate, time of day, miles ridden, total time riding, location of ride (e.g., GPS), actual routes ridden, temperature throughout ride, personal record times, level of exertion, total hours ridden (e.g., daily, weekly, yearly, etc.) and the like. In particular embodiments, the monitoring device input 204 may be used to identify friends that have also joined the user on an activity. As an example and not by way of limitation, in order to track the people that joins the user on an activity, each of the users may be signed-in to and/or associated with the cycling data platform 160 and opted to share their locations with the cycling data platform 160. These locations may be compared to the time of day corresponding to the geographic locations in order to identify users in close proximity to one another within a similar time window. As another example and not by way of limitation, each of the users may input data into the cycling data platform 160 (e.g., via separate individual user inputs 202). The performance of the user may be compared to his or her friends. The data may be anonymized by generalizing the data for the user to review. As an example and not by way of limitation, information corresponding to the data based on a comparison of the user to his or her friends may include “You're riding 20% more often than your friends,” which may be shared to the user via a cycling application 134.

In particular embodiments, the third-party input 206 may be received from one or more third-party systems 170. As an example and not by way of limitation, the third-party input 206 may be received from partners of the cycling data platform 160, such as e-commerce sites. In particular embodiments, the third-party input 206 may include purchase data, event data, and other cycling information corresponding to a user. As an example and not by way of limitation, the third-party input 206 may include purchase data that are tracked via cookies. The purchase data may indicate which brands the user is interested in purchasing and/or repurchasing. Additionally, the purchase data may provide a quantity of an item the user purchased, which may be used to determine when a user may need to repurchase an item. As another example and not by way of limitation, the third-party input 206 may include event data that corresponds to websites hosting events (e.g., cycling races). The event data may include user information (e.g., user's name, time, etc.) that corresponds to the user. The event data may be verified by the user to ensure accuracy of the data. As another example and not by way of limitation, the third-party input 206 may include previous bike maintenance information for the user, such as when a user previously repaired his or her bike. In particular embodiments, the third-party input 206 may be sent to the cycling data platform 160. The third-party input 206 may also be requested by the cycling data platform 160.

In particular embodiments, the cycling data platform 160 may determine when to send notifications or reminders to the user to purchase products. As an example and not by way of limitation, the cycling data platform 160 may determine when to send a notification to a user to purchase a tire that has worn down. In particular embodiments, the user may be subscribed to particular items and/or under a general cycling experience management where the cycling data platform 160 may identify various items that the user may be interested in buying. As an example and not by way of limitation, the user may have previously bought supplements used for cycling and the cycling data platform 160 may determine when to send a notification to the user to repurchase the supplements. As another example and not by way of limitation, under a general cycling experience management plan, the cycling data platform 160 may determine when to repurchase bike tires (specific to the user's equipment), bike chain, other bike parts, and the like. In particular embodiments, the user may be subscribed to a customized plan where certain items are identified that the user may be interested in buying. As an example and not by way of limitation, if the user continually repurchases cycling ware, then the cycling data platform 160 may determine to identify when to send notifications to the user to repurchase the cycling ware. In particular embodiments, the cycling data platform 160 may include a data manager 210, a recommendations engine 212, a subscription module 214, a recommendation module 216, a notification module 218, and a feedback module 220.

In particular embodiments, the data manager 210 may receive the data including the user input 202, monitoring device input 204, the third-party input 206, and other data and reformat the data to be analyzed by the recommendations engine 212. In particular embodiments, the data manager 210 may generalize data received from a plurality of users (e.g., subject to privacy settings of the user) in order to provide better recommendations for purchasing and content for the user. In particular embodiments, the data manager 210 may manage content stored by the cycling data platform 160. As an example and not by way of limitation, the data manager 210 may manage videos and posts by users of the cycling data platform 160 that may be shared among the users. In particular embodiments, the data manager 210 may send the data to the recommendations engine 212 after collecting the data corresponding to the user to be analyzed.

In particular embodiments, the recommendations engine 212 may analyze the data received from the data manager 210 to generate a user profile of the user. The user profile may include a cycling profile of the user indicating one or more cycling characteristics of the user as described herein. The user profile may be used to identify content the user would be interested in seeing. As an example and not by way of limitation, the recommendations engine 212 may generate a counter indicative of when the user may need to perform maintenance on his or her bike, which may be stored in the user profile. When the counter indicates the user needs to perform maintenance, the recommendations engine 212 may identify content, such as a bike maintenance video for the user to view. For example, how to change the tires on the bike, how to lubricate the bike chain, and the like. As another example and not by way of limitation, based on the monitoring device input 204, the recommendations engine 212 may identify frequent routes the user may ride. The recommendations engine 212 may identify similar cycling routes (e.g., same distance, same pavement, elevation changes, temperature changes, and the like) to suggest the cyclist to ride. The content the recommendations engine 212 may identify may be a GPS mapped out ride for the user to input into their client system. In particular embodiments, the recommendations engine 212 may identify previous content the user has viewed and identify similar content the user may be interested in viewing. As an example and not by way of limitation, the recommendations engine 212 may identify inspirational videos the user watched previously and identify other inspirational videos the user may be interested in watching. In particular embodiments, the recommendations engine 212 may classify users based on their user profile. In particular embodiments, the recommendations engine may classify users based on a cycling profile component of their respective user profiles. As an example and not by way of limitation, the cycling profile may indicate that a particular user is an off-road cyclist. Users may be classified as an off-road cyclist by the recommendations engine 212. The recommendations engine 212 may identify similarities between classified users. As an example and not by way of limitation, the recommendations engine 212 may identify that a majority of mountain-bike riders may purchase a particular product. The recommendations engine 212 may associate the particular product with the user classification. As another example and not by way of limitation, the recommendations engine 212 may identify routes or route characteristics (e.g., flat road, low traffic, good weather conditions) that a particular user classification may like to ride and associate those route characteristics with the particular user classifications.

In particular embodiments, the recommendations engine 212 may use the user input 202, monitoring device input 204, and the third-party input 206 to identify the content the user would be interested in seeing and items the user would be interested in purchasing. In particular embodiments, the recommendations engine 212 may develop a user profile for the specific user and adjust recommendations based on the user. In particular embodiments, the recommendations engine 212 may include self-healing artificial intelligence. As an example and not by way of limitation, the recommendations engine 212 may incorporate feedback from the user to adjust the recommendations. For example, if the user decides to purchase an item earlier than anticipated, the recommendations engine 212 may identify the user's consuming habits and update when to recommend repurchasing the item. The recommendations engine 212 may communicate this information with the subscription module 214. Similarly, if the user defers to purchase an item, the recommendations engine 212 may update the user profile corresponding to when to recommend the user to repurchase items. In particular embodiments, the recommendations engine 212 may send the identified content and identified products to the recommendation module 216. Although described as a single recommendations engine 212, the recommendations engine 212 may comprise multiple recommendations models. As an example and not by way of limitation, there may be a recommendations model created individually for each part of a bike. Another recommendations model may be directed to content and another recommendations model may be directed to products the user may be interested in purchasing.

In particular embodiments, the subscription module 214 may analyze the data received from the data manager 210 to identify items the user would be interested in purchasing. As an example and not by way of limitation, the subscription module 214 may identify previously purchased items by the user and determine when to recommend the user to repurchase the items. While certain functions are described as being performed by the subscription module 214, one or more functions may be performed by the recommendations engine 212. A base health profile of the user may be determined based on the received data by the recommendations engine 212. As an example and not by way of limitation, an estimate of how often the user may consume products may be determined based on the age, weight, and other attributes of the user. This information may be added to the user profile of the user. The subscription module 214 may use this information to determine how often a user may consume a particular product. The subscription module 214 may comprise a recommendations model that analyzes the received data to determine when to recommend purchasing products. Additionally, the subscription module 214 may calculate calories burned and what that would equate to a consumable. As an example and not by way of limitation, the subscription module 214 may equate 500 calories burned to a consumable gel that is used for cycling. The subscription module 214 may monitor when a user previously purchased a 12-pack of the consumable gel and may identify when the user may need to repurchase the product. The time to repurchase may be calculated based on average shipping times for the product and when the user would run out of the product based on average activity. As an example and not by way of limitation, if it is determined the user consumes a consumable gel every day for cycling (based on previous ride data) and the shipping time for the product is three days (based on product information/website information), then the subscription module 214 may identify that the user should repurchase the product three days prior to finishing the product. As another example and not by way of limitation, when a user initially generates a user profile with the cycling data platform 160, the user may input the equipment the user has to be used for activities (e.g., cycling). The subscription module 214 may identify bike parts that correspond to the equipment and set a counter of when to repurchase the identified bike parts. This may be based on ride data (e.g., monitoring device input 204) received from the monitoring device 140 compared to statistics corresponding to the respective bike parts. For instance, for a given brand of bike tire, the specific bike tire may be listed to be changed every 2000 miles. The subscription module 214 may analyze the user's ride data via monitoring device input 204 to identify when a user may need to change the bike tire. Additionally, the subscription module 214 may use additional data such as weather, where the bike tire may last longer if used on slick roads (e.g., bike rides that occur after it rains or during a drizzle). The subscription module 214 may calculate when to repurchase an item as described herein.

In particular embodiments, the recommendation module 216 may select and generate content recommendations for the user to view. To do so, the recommendation module 216 may access the user profile that is generated and updated by the recommendations engine 212. The selected content to recommend may be based on the identified content from the recommendations engine 212. After the recommendations engine 212 identifies the content a user would be interested in viewing, the recommendation module 216 may select corresponding content to match the identified criteria matching the user profile. In particular embodiments, the recommendations engine 212 may identify tags or attributes associated with content the user may be interested in viewing and update the user profile of the user with the tags. The recommendation module 216 may use the tags of the user profile to identify the specific content a user may be interested in viewing. As an example and not by way of limitation, the recommendations engine 212 may identify the user would be interested in viewing content that includes the tags “bike”, “maintenance”, and “tire replacement”, and update the user profile of the user to include those tags. The recommendation module 216 may use the user profile to identify the corresponding content that includes those tags to identify the most relevant content the user would be interested in viewing. In particular embodiments, the content may be one or more of a post, video, and the like. In particular embodiments, the recommendation module 216 may modify an interface of an application or website associated with the cycling data platform 160 to present the content to the user. As an example and not by way of limitation, if a user signs into his or her account on a website (or application) associated with the cycling data platform 160, the user may be presented the recommended content. The recommendation module 216 may send a request to the notification module 218 to notify the user of new content to view. In particular embodiments, only certain content may utilize the request to notify the user in order to reduce unwanted or unnecessary notifications. In particular embodiments, the recommended content may include cycling schedules and cycling recommendations. As an example and not by way of limitation, if the recommendations engine 212 identifies the user as cycling a certain amount each week, the recommendations engine 212 may identify a preferable cycling schedule based on previous cycling habits. As an example and not by way of limitation, if the user typically rides his or her bike when the temperatures are around 55-77 degrees, then the recommendations engine 212 may identify days of the week that may be optimal to ride. Additionally, if the user prefers to ride when it is sunny, the recommendations engine 212 may identify sunny days of the week and when to ride. The identified information may be added and/or associated with the user profile of the user. As an example and not by way of limitation, a cycling profile of the user may be updated with the cycling information of the user. The recommendation module 216 may generate a schedule of when to ride for the upcoming week for the user to review based on the user profile. The user may alter the schedule directly indicating when the user would prefer to ride. In particular embodiments, the recommendation module 216 may request the notification module 218 to notify the user of the cycling schedule. In particular embodiments, the recommendations engine 212 may identify similar routes the user may be interested in cycling as described herein. The recommendation module 216 may generate and identify a route that the user may be interested in trying based on previous cycling behaviors and using the user profile of the user. If the user typically accepts cycling route recommendations, the recommendation module 216 may continually generate cycling route recommendations. The cycling route recommendation may comprise a link to a navigation application to implement the cycling route for the user to follow. In particular embodiments, the recommendations engine 212 may identify frequent friends the user typically cycles with throughout the week and update the user profile of the user with this information. The recommendation module 216 may request the notification module 218 to generate a notification for the user to view that a friend is currently riding. The recommendations engine 212 may identify whether the user would like to be continually updated based on the user reaction (e.g., if the user views the notification and prepares to cycle or if the user views the notification and ignores the notification). In particular embodiments, the recommendation module 216 may generate a cycling route of what the user should expect for their ride. As an example and not by way of limitation, the recommendation module 216 may compile information indicative of wind direction and speed, temperature/humidity, traffic volume and speed, water stops, road quality, and the like corresponding to the user's cycling route (e.g., a cycling route the user may typically ride, a suggested cycling route, etc.) to send to the user to view. The information compiled by the recommendation module 216 may be retrieved from a plurality of sources, such as user input 202, third-party input 206, and input from other users of the cycling data platform 160. A user profile may indicate certain conditions, route characteristics, and the like that the user may prefer with their rides. This information may be used to generate routes for the user to ride. As an example and not by way of limitation, if a user's previous routes indicate that the user rides on routes with at least one water stop, then the recommendation module 216 may generate routes and send recommendations with at least one water stop.

In particular embodiments, the recommendation module 216 may select and generate recommendations and/or reminders for the user to purchase a product. The recommendations and/or reminders may be based on the identified products from the recommendations engine 212 as described herein. After the recommendations engine 212 identifies the product a user would be interested in purchasing, the recommendation module 216 may generate a list including the identified product that the user would be interested in purchasing. In particular embodiments, the recommendations engine 212 may generate a user profile corresponding to a fitness profile of the user. The fitness profile may be based on the received user input 202 and indicate how many calories the user may consume for an activity. In particular embodiments, a standard and configurable parameters for time/effort to replace consumables may be calculated. As an example and not by way of limitation, a sports drink may equate to 500 calories burned. In particular embodiments, the recommendation module 216 may identify similar products the user may be interested in purchasing based on previous purchasing habits. Additionally, other purchasing habits of similar users may be used to recommend certain products. As an example and not by way of limitation, if other users who have a similar user profile (e.g., have similar purchasing habits) buy a different product, the recommendations engine 212 may identify the different product for the user to purchase. As described herein, the subscription module 214 may monitor the user's activity (e.g., cycling habits) and determine when to purchase products, such as consumables and bike parts. In particular embodiments, the subscription module 214 may generate multiple profiles for a user. As an example and not by way of limitation, if a user initially indicates that the user has multiple bikes, the subscription module 214 may track the riding of each individual bike. The tracking of each bike may monitor the use of the parts of each bike and determine when the respective parts may need to be replaced. As an example and not by way of limitation, the cycling data platform 160 may request feedback from the user to indicate which bike the user rode. As another example and not by way of limitation, the subscription module 214 may identify which bike the user may use for a particular cycling route. For instance, if the user has a mountain bike and a road bike, the subscription module 214 may determine that the user may have rode a mountain bike for a cycling route that maps to an off-road route. The subscription module 214 may also identify cycling habits of the user. For example, for a specific cycling route, the user typically uses a particular bike, or the user typically uses a particular bike for certain weather, etc. As described herein, the subscription module 214 may calculate when to remind the user to purchase a product. In particular embodiments, the recommendation module 216 may simply request the notification module 218 to remind the user it may be time to repurchase a product based on the calculation or when the subscription module 214 determines the product will run out. In particular embodiments, the recommendation module 216 may send a request to the notification module 218 to generate a reminder for the user to purchase a product.

In particular embodiments, the notification module 218 may generate notifications and/or reminders to send to the client system 130. In particular embodiments, the notifications and reminders may be a pop up on the client system 130, an email to an email address associated with the user, or the like. In particular embodiments, the notification module 218 may receive requests to send notifications and reminders to the user from the recommendation module 216. In particular embodiments, the notification module 218 may generate instructions to send to the client system 130 to present a notification to the user of a recommendation. The recommendation may be content (e.g., video, post, etc.) a user may be interested in viewing as described herein. The recommendation may be a recommendation and/or reminder to purchase an item/product that the user may have previously purchased or may be interested in purchasing.

In particular embodiments, the feedback module 220 may receive a user input 202 from the client system 130 indicative of feedback corresponding to the recommendations. In particular embodiments, the client system 130 may send data indicative of whether a user viewed content (e.g., watched a video completely, rode a recommended cycling route, implemented a cycling schedule) or made a purchase based on a recommendation or reminder. The feedback module 220 may receive the data and analyze the data to generate feedback to update a user profile using the recommendations engine 212. As an example and not by way of limitation, while the subscription module 214 may initially use a standard 1 consumable gel for a cycling route, if the user purchases the product corresponding to the consumable gel in half the predicted time, the subscription module 214 may adjust parameters associated with the user profile to indicate that the user may use 2 consumable gels for a cycling route. The recommendations engine 212 and subscription module 214 may gather data from multiple users to determine when specific bike parts need to be replaced. As an example and not by way of limitation, if a specific bike tire is replaced about every 2000 miles, then the subscription module 214 may determine to remind the user to purchase a replacement bike tire every 2000 miles. However, if the average user replaces the bike tire every 1900 miles, the subscription module 214 may update information corresponding to that bike tire to reflect the consumption rate of the average user. Additionally, characteristics of the user's cycling environment may be used to further characterize different cycling behaviors and replacement schedules. As an example and not by way of limitation, a user in a mainly flat environment may not need to replace brakes on a bike as frequently as a user in a hilly environment. The subscription module 214 may further use data to determine a replacement schedule for a bike part. In particular embodiments, the feedback module 220 may update a user profile of the user to change recommended content, recommended products, and recommended product replacement schedules.

In particular embodiments, the client system 130 may receive instructions to present a notification from the cycling data platform 160. In particular embodiments, the notification may comprise a link to open an application or website corresponding to a cycling data platform 160. In particular embodiments, the selection of a notification and/or reminder to purchase a product may display an order to purchase the product. In particular embodiments, the user may confirm the purchase through a selection of an activatable element. As an example and not by way of limitation, the user may press a button to confirm the purchase of a bike tire. The user may adjust purchasing settings prior to confirming a purchase of a product. As an example and not by way of limitation, billing information, delivery information, and the like may be updated prior to confirming a purchase. In particular embodiments, the user may update settings to automatically purchase a product. As an example and not by way of limitation, consumables may be purchased/repurchased automatically when the subscription module 214 determines the user may have run out of the product.

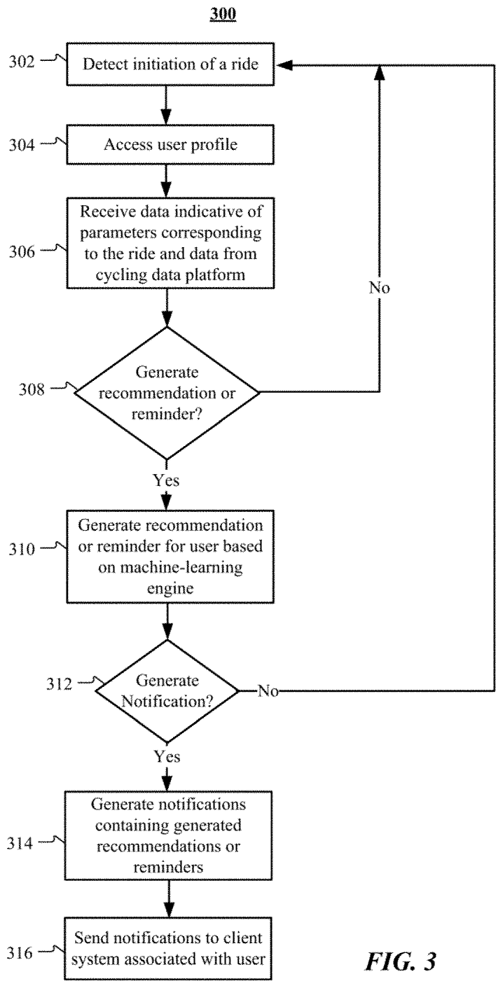

FIG. 3 illustrates an example flow diagram of a notification process 300 of a cycling data platform. The process 300 may start with step 302, where a component of a cycling data platform environment may detect an initiation of a ride. As an example and not by way of limitation, a monitoring device may receive an indication of an initiation of a cycling route by a user. In step 304, a component of a cycling data platform environment may access a user profile of the user. As an example and not by way of limitation, a cycling data platform may access a user profile of the user who initiated the ride. In step 306, one or more components of a cycling data platform environment may receive data indicative of parameters corresponding to a ride and data from a cycling data platform. As an example and not by way of limitation, a monitoring device may receive data corresponding to distance traveled, calories burned, etc. Another device may receive data corresponding to a cycling route, such as weather, temperature, elevation changes, traffic, etc. A cycling data platform may access data stored on the cycling data platform. The data from the cycling data platform may indicate one or more friends associated with a user may be riding in the vicinity of the user. Other data stored on the cycling data platform may be used, such as user classifications that match the user profile. In step 308, a component of a cycling data platform environment may be used to determine whether to generate recommendations or reminders. As an example and not by way of limitation, a recommendation module may use a user profile and other data to identify content a user may be interested in viewing as described herein. As an example and not by way of limitation, a subscription module may be used to determine whether a user needs to purchase a product (e.g., to replace a consumed product, or a bike part). If the subscription module identifies a product to remind the user to purchase, then the component of the cycling data platform environment may determine that a reminder for a product purchase needs to be generated. As another example and not by way of limitation, the recommendation module may identify one or more friends of the user is currently cycling and determine the user may want to be recommended to ride with friends. If the recommendation module identifies content (e.g., a recommendation to join other users for a ride) for the user to be viewed or a product to be purchased, the component of the cycling data platform environment may determine that a recommendation or reminder needs to be generated and proceed to step 310, where a recommendation or reminder is generated for the user to view as described herein. If no recommendations or reminders are to be generated, then the process 300 may return to step 302, where the process 300 may restart. At step 312, a component of the cycling data platform environment may determine whether to generate a notification to send to the user. Not all identified content will require a notification for the user to see. Instead, the content may be presented to the user when the user next opens an application associated with the cycling data platform. A notification may be generated for a product purchase. As an example and not by way of limitation, if a reminder for a product purchase is generated, a notification may be generated for the user to view to repurchase a product. If a generated recommendation contains a request for a user to join friends for a ride, a notification may be generated for the user to view. If a notification is generated, the process 300 may proceed to step 314 where a component of the cycling data platform environment may generate notifications containing generated recommendations and/or reminders. As an example and not by way of limitation, a notification module may receive a request to generate a notification for a recommendation. If a notification is not generated, the process 300 may return to step 302 to restart the process 300. After step 314, the process 300 may continue to step 316, where a component of the cycling data platform may send notifications to a client system associated with the user as described herein. As an example and not by way of limitation, a notification may be sent to the user's smartphone where they can be notified friends are currently riding nearby. The notification may contain a route to follow to join friends nearby. In particular embodiments, the friends may be notified as well.

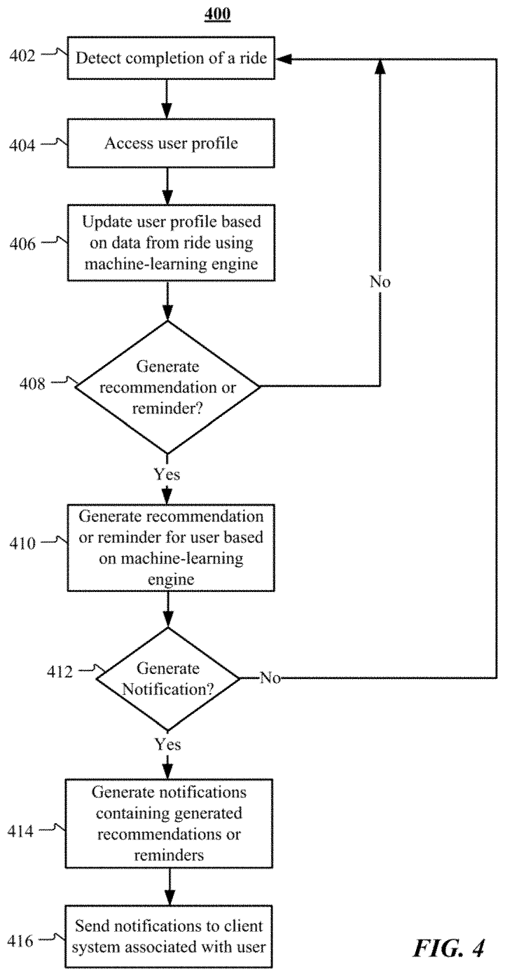

FIG. 4 illustrates an example flow diagram of a notification process 400 of a cycling data platform. The process 400 may start with step 402, where a component of a cycling data platform environment may detect completion of a ride. As an example and not by way of limitation, a monitoring device may receive an indication of a completion of a cycling route by a user. For instance, the user may return to a home location associated with the user. In step 404, a component of a cycling data platform environment may access a user profile of the user. As an example and not by way of limitation, a cycling data platform may access a user profile of the user who initiated the ride. In step 406, one or more components of a cycling data platform environment may update a user profile based on data from the ride using a recommendations engine. As an example and not by way of limitation, a cycling data platform may initiate a user profile update process by applying a recommendations engine on data received from a monitoring device after completion of a ride. The recommendations engine may identify one or more route characteristics to update the user profile. As an example and not by way of limitation, if a user rides a new route, the new route characteristic may be added to the user profile of the user. For instance, if the new route was flat, with no traffic, and consisted mainly of roads, the user profile may be updated with that information. This information may indicate that the user may be interested in further routes that are flat, with no traffic, and consists of mainly roads (as opposed to off-road routes). In step 408, a component of a cycling data platform environment may be used to determine whether to generate recommendations or reminders. As an example and not by way of limitation, a recommendation module may use a user profile and other data to identify content a user may be interested in viewing as described herein. As an example and not by way of limitation, a subscription module may be used to determine whether a user needs to purchase a product (e.g., to replace a consumed product, or a bike part). If the subscription module identifies a product to remind the user to purchase, then the component of the cycling data platform environment may determine that a reminder for a product purchase needs to be generated. As an example and not by way of limitation, the subscription module may determine a number of calories burned by the user based on the completed route and perform calculations to determine how many consumables may have been used for the completed route based on prior user activity. If for instance a recommendation module identifies content for the user to be viewed or a product to be purchased, the component of the cycling data platform environment may determine a recommendation or reminder needs to be generated and proceed to step 410, where a recommendation or reminder is generated for the user to view as described herein. If no recommendations or reminders are to be generated, then the process 400 may return to step 402, where the process 400 may restart. At step 412, a component of the cycling data platform environment may determine whether to generate a notification to send to the user. Not all identified content will require a notification for the user to see. Instead, the content may be presented to the user when the user next opens an application associated with the cycling data platform. A notification may be generated for a product purchase. As an example and not by way of limitation, if a reminder for a product purchase is generated, a notification may be generated for the user to view to repurchase a product. If a notification is generated, the process 400 may proceed to step 414 where a component of the cycling data platform environment may generate notifications containing generated recommendations and/or reminders. As an example and not by way of limitation, a notification module may receive a request to generate a notification for a reminder to purchase a product. If a notification is not generated, the process 400 may return to step 402 to restart the process 400. After step 414, the process 400 may continue to step 416, where a component of the cycling data platform may send notifications to a client system associated with the user as described herein.

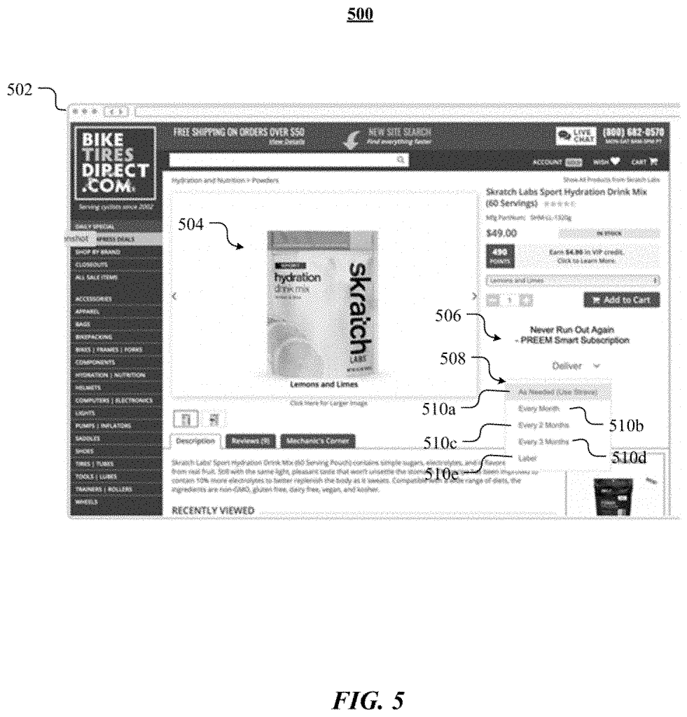

FIG. 5 illustrates an example user interface 502 of a website environment 500 including a subscription service provided by the cycling data platform 160. In particular embodiments, the user interface 502 may be a website of an e-commerce website. In particular embodiments, the user interface 502 may be directed to a product 504 and implement a subscription service add-on 506. In particular embodiments, the subscription service add-on 506 may be a web plug-in used by a third-party system 170 to access a subscription service provided by the cycling data platform 160. In particular embodiments, the subscription service add-on 506 may include a drop down 508 including options 510a-510e. The options 510a-510e may correspond to frequency of when to purchase a product. Option 510a may use a recommendations engine and a monitoring device to determine when to purchase a product. The user may have an account with a subscription service that is linked to the cycling data platform. If the user selects option 510a, then the cycling data platform may determine when a user may need to purchase product 504 based on the user activity as described herein. While a website environment 500 is shown, other environments may use the subscription service add-on 506. As an example and not by way of limitation, an application may use the subscription service add-on 506.

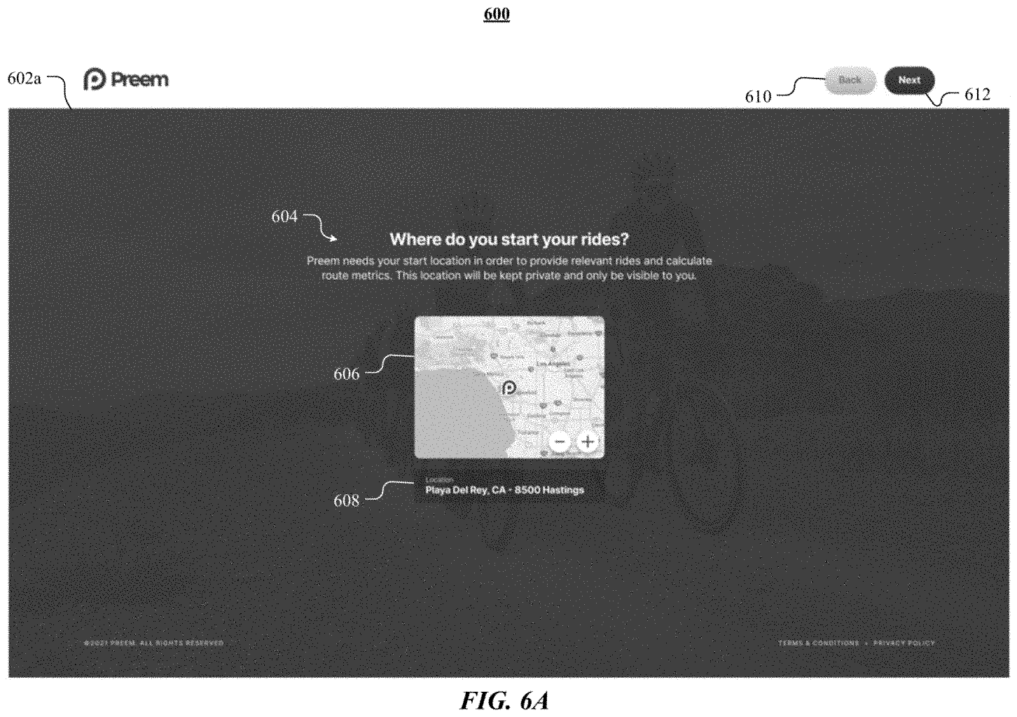

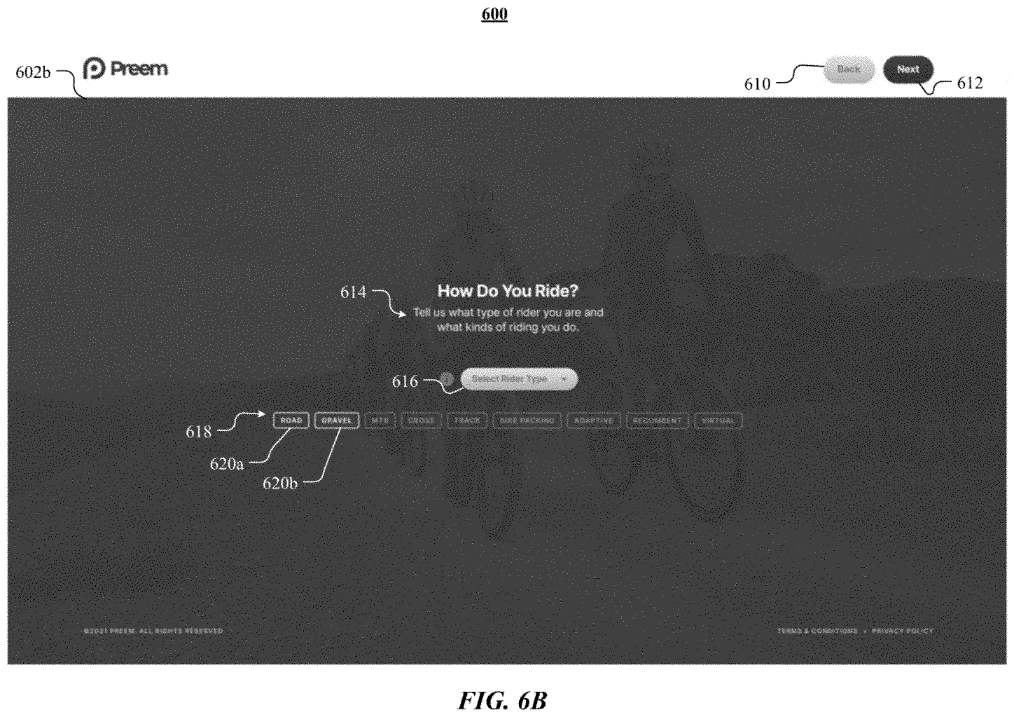

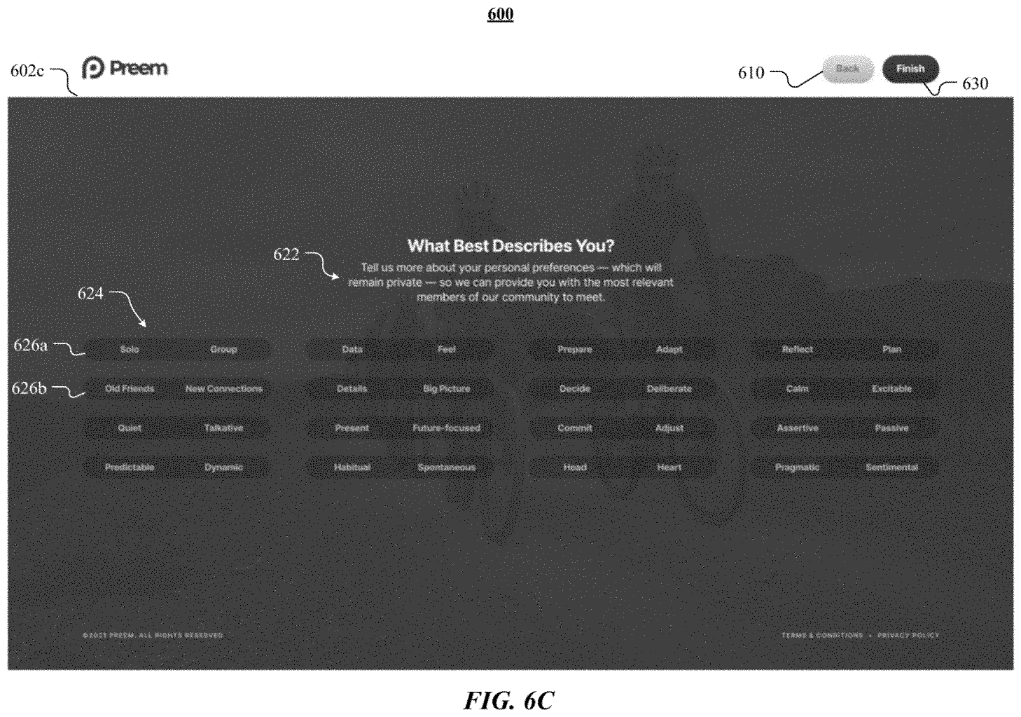

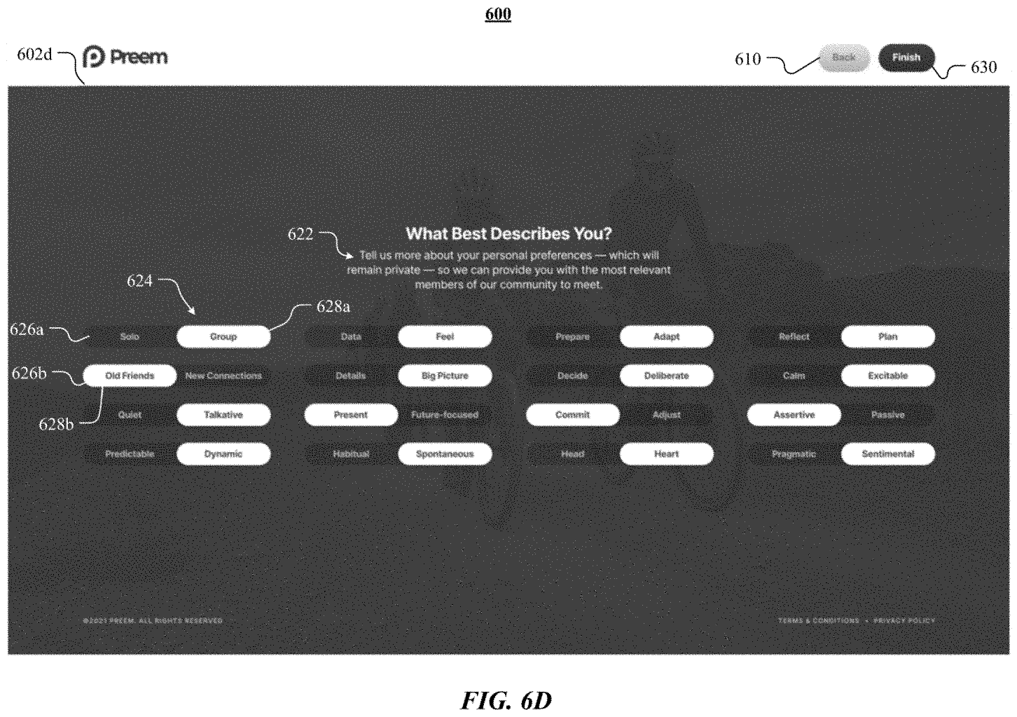

FIGS. 6A-6D illustrate example user interfaces for creating a cycling profile associated with a cycling data platform 160. Referring to FIG. 6A, a user interface 602a of a website environment 600 provided by a cycling data platform 160 is shown. In particular embodiments, the user interface 602a can be a user interface of a cycling application 134 installed on a client system 130. A user (e.g., a cycling user interfacing a client system) can initiate the user interface 602a through one or more web portals associated with a cycling data platform 160. As an example and not by way of limitation, a user may be prompted to log into a cycling profile or initially create a cycling profile when visiting a home page of a website associated with a cycling data platform 160. The user interface 602a can include a prompt 604 requesting the user to input one or more locations where the user typically initiates a cycling ride (e.g., a bicycle ride). The user interface 602a can include a map 606 representing a location selected by the user. As an example and not by way of limitation, the user may drop a pin representing the starting location of his or her cycling routes. The user interface 602c can include an input box 608 for the user to input a location via a keyboard or digital keyboard (not shown). The input box 608 may also be automatically populated in response to a selection of a location on the map 606. The user interface 602a can include an activatable element 610 to return to a previous page. As an example and not by way of limitation, the activatable element 610 can be a back button. The user interface 602a can include an activatable element 612 to proceed to the next page. As an example and not by way of limitation, the activatable element 612 can be a next button.

Referring to FIG. 6B, a user interface 602b of a website environment 600 provided by a cycling data platform 160 is shown. In response to the user selecting activatable element 612 of user interface 602a, the user interface 602a can transition to user interface 602b. User interface 602b can include a prompt 614 requesting the user to input details corresponding to how the user rides. The user interface 602b can include a drop down menu 616 for the user to select a rider type. The user interface 602b can include a plurality of cycling characteristics 618 including a road characteristic 620a, a gravel characteristic 620b, and the like. As shown in FIG. 6B, the user can select one or more of the cycling characteristics 618 to represent the how the user rides. The user interface 602b can include an activatable element 610 to return to a previous page (e.g., user interface 602a). As an example and not by way of limitation, the activatable element 610 can be a back button. The user interface 602b can include an activatable element 612 to proceed to the next page. As an example and not by way of limitation, the activatable element 612 can be a next button.

Referring to FIG. 6C, a user interface 602c of a website environment 600 provided by a cycling data platform 160 is shown. In response to the user selecting activatable element 612 of user interface 602b, the user interface 602b can transition to user interface 602c. The user interface 602c can include a prompt 622 requesting the user to input personal preferences 624 of the user. The personal preferences 624 can include one or more preferences 626a, 626b for the user to select. As an example and not by way of limitation, the user can select whether they have a solo riding preference 626a or a group riding preference 626a. The user interface 602c can include an activatable element 610 to return to a previous page (e.g., user interface 602b). As an example and not by way of limitation, the activatable element 610 can be a back button. The user interface 602c can include an activatable element 630 to proceed to the finish the cycling profile. As an example and not by way of limitation, the activatable element 630 can be a finish button.

Referring to FIG. 6D, a user interface 602d of a website environment 600 provided by a cycling data platform 160 is shown. User interface 602d illustrates a user selecting one or more personal preferences 624 of user interface 602c. The user interface 602d can include similar elements as user interface 602c. The user interface 602d can include one or more selections 628a, 628b of the user for each of the personal preferences 624 displayed in user interface 602d. After the user is finished with making a selection 628 for each of the personal preferences 624, the user can proceed with selecting the activatable element 630 to complete the cycling profile.

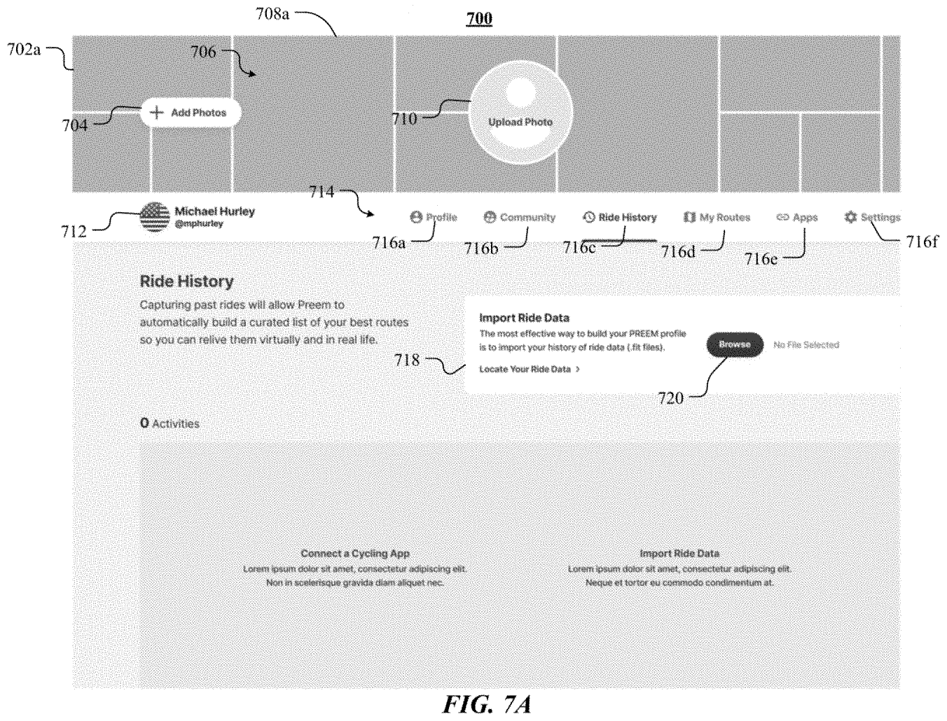

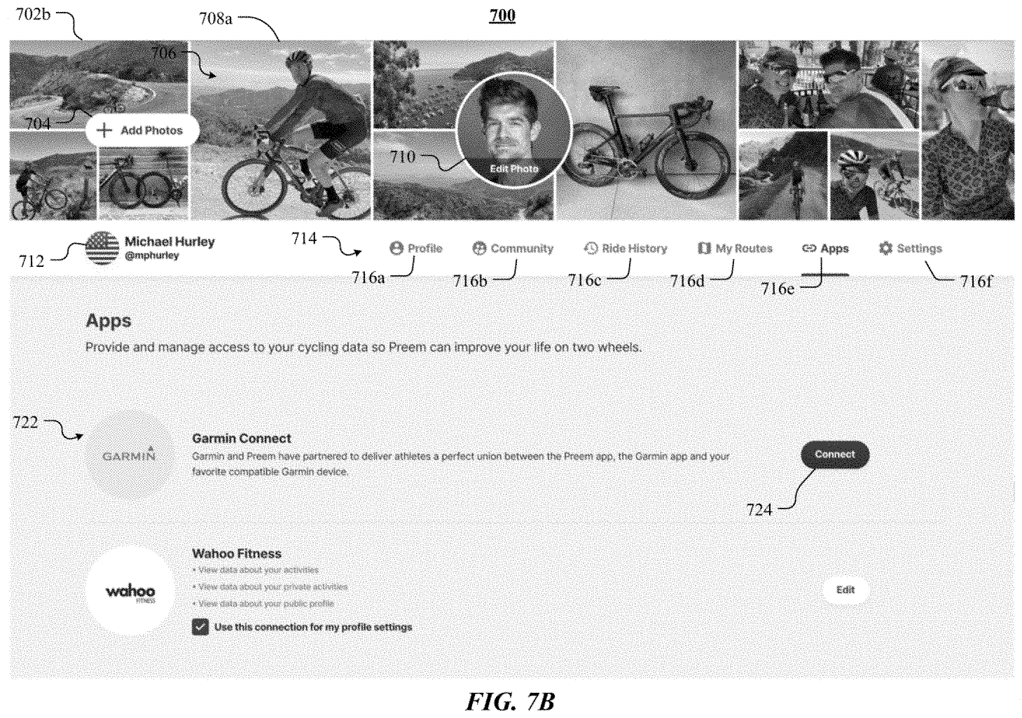

FIGS. 7A-7B illustrate example user interfaces for importing cycling data onto a cycling data platform. Referring to FIG. 7A, a user interface 702a of a website environment 700 provided by a cycling data platform 160 is shown. In particular embodiments, the user interface 702a can be a user interface of a cycling application 134 installed on a client system 130. A user (e.g., a cycling user interfacing a client system) can initiate the user interface 702a through one or more web portals associated with a cycling data platform. The user interface 702a can represent a cycling profile homepage of a user. The user interface 702a can include an activatable element 704 to add photos to user interface elements 706 (e.g., a photo box 708) of the cycling profile of the user. The user interface 702a can include an activatable element 710 to add a photo to the cycling profile of the user. The user interface 702a can include a name and user name associated with the cycling profile. The user interface 702a can include tabs 714 of activatable elements 716a-716f to view different web portals of the cycling data platform 160. As an example and not by way of limitation, the ride history tab 716c can be highlighted to represent the user interface 702a corresponds to the ride history tab 716c. The user interface 702a can represent an initial set up of a cycling profile where a user does not have any cycling data. The user interface 702a can include an import ride data box 718 including an activatable element 720 to browse files on the client system 130 to upload cycling data to the cycling data platform 160.

Referring to FIG. 7B, a user interface 702b of a website environment 700 provided by a cycling data platform 160 is shown. In particular embodiments, the user interface 702b can include similar elements of user interface 702a. In particular embodiments, the user interface 702b can represent a user interface associated with the apps tab 716e. In response to the user selecting the apps tab 716e, the user interface 702b can be shown. The user interface 702b can include a list of apps including an application 722 with an activatable element 724. The activatable element 724 can be selected by the user to connect the client system 130 to a third party system associated with the application 722. The client system 130 can access a database associated with a third party system to retrieve ride data associated with the user.

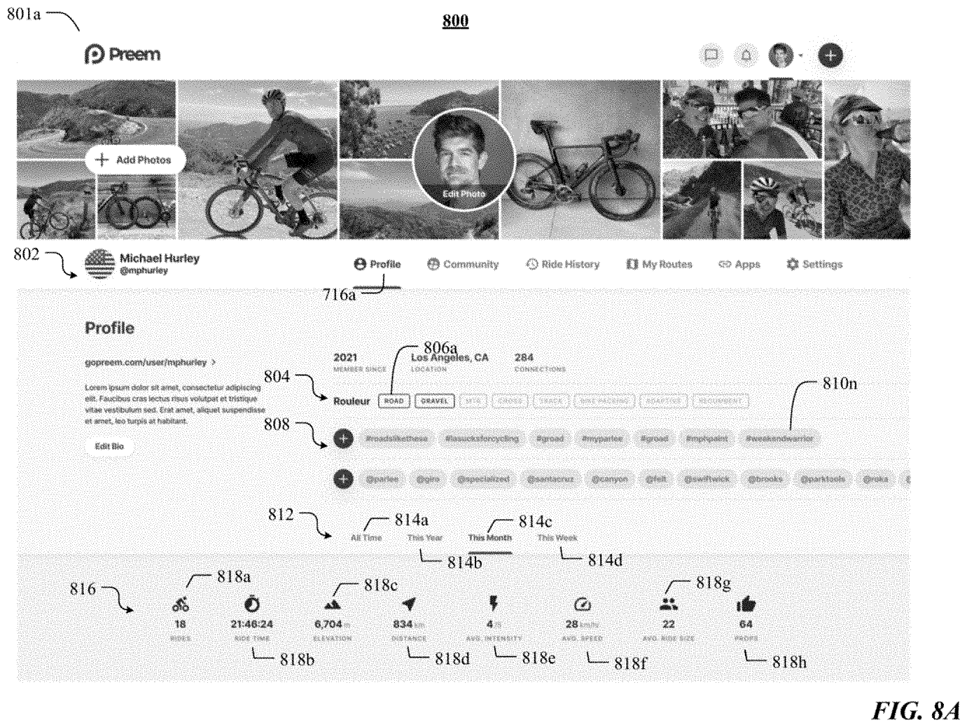

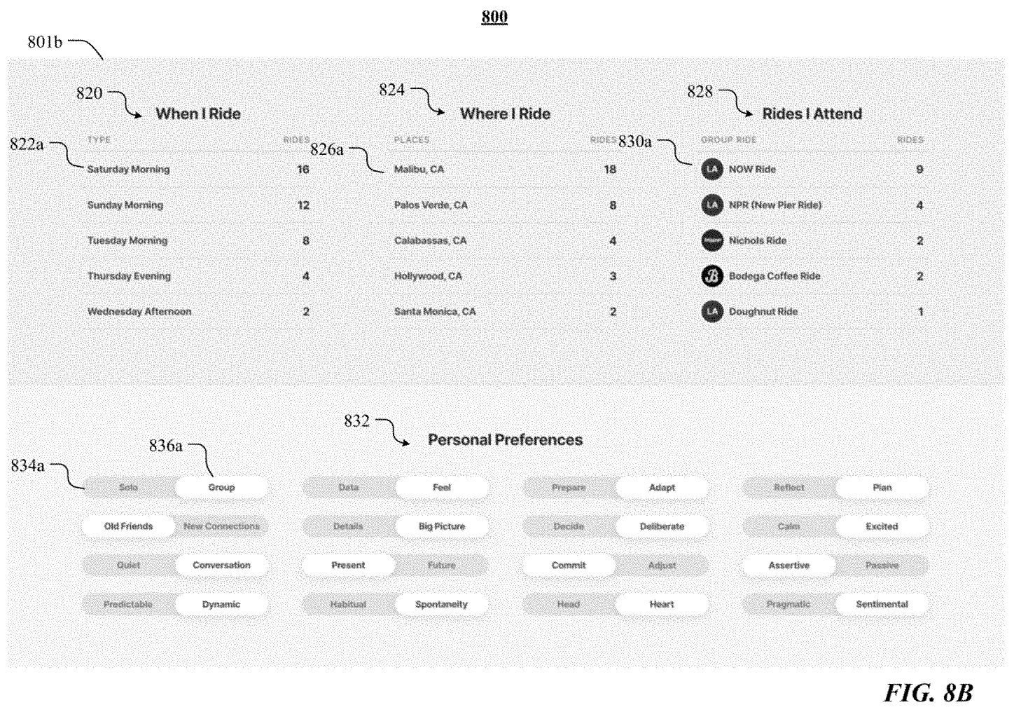

FIGS. 8A-8B illustrate example user interfaces 801a-801b of a cycling profile associated with a cycling data platform 160. Referring to FIG. 8A, the user interface 801a can be a user interface of a website environment 800 provided by a cycling data platform 160. The user interface 801a can be accessed through a selection of the profile tab 716a of user interface 702a-702b. The user interface 801a can include a profile element 802 representing the cycling profile of the user. The user interface 801a can include ride characteristics 804 of the user, such as a roach characteristic 806a. The user interface 801a can include one or more tags 808 associated with the user, such as weekend warrior 810n that represents a cycling behavior/characteristic of the user. The user interface 801 can include tabs 812 of time periods 814a-814d of cycling statistics 816 associated with the cycling profile. The user interface 801a illustrates that the time period 814c can be selected. The time period 814c can represent the cycling statistics 816 of the user in the past month. The cycling statistics 816 can include number of rides 818a, total ride time 818b, total elevation climbed 818c, total distance 818d, average intensity 818e, average speed 818f, average ride size 818g, and props 818h. While only a number of cycling statistics 816 are shown, this disclosure contemplates displaying any number of cycling statistics 816 in any particular arrangement. As an example and not by way of limitation, the cycling statistics 816 can include additional cycling statistics 816 not shown. Referring to FIG. 8B, the user interface 801b can include time statistics 820 indicative of when the user rides during the time period 814c. The time statistics 820 can include one or more time periods 822, such as Saturday morning 822a. The time periods 822 can be adjusted based on the selected time period 814. The user interface 801b can include location statistics 824 of where the user rides during the time period 814c. The location statistics 820 can include one or more locations 826, such as Malibu, Calif. 826a. The user interface 801b can include group statistics 828 of which groups the user rode with during the time period 814c. The group statistics 828 can include one or more groups 830, such as NOW ride 830a. The user interface 801b can present the personal preferences 832 of the user including preferences 834 with a corresponding selection 836. As an example, for the preference “solo” or “group” 834a, a selection of “group” 836a can be displayed as being selected. In particular embodiments, the personal preferences can be updated based on how the user rides. As an example and not by way of limitation, the cycling data platform 160 can receive cycling data from the user based on one or more recent rides and update the cycling profile of the user based on the cycling data.

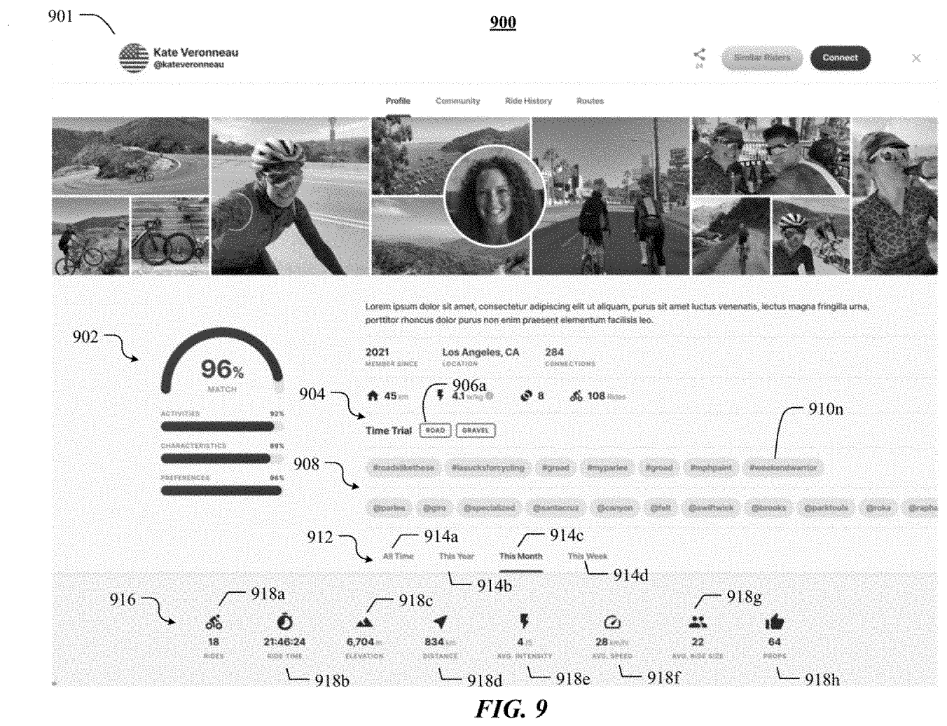

FIG. 9 illustrates an example user interface 901 of a match score on a cycling profile associated with a cycling data platform 160. The user interface 901 can represent a user profile of another user of the cycling data platform 160. As an example and not by way of limitation, the user interface 901 can represent the view of a user looking at another user's cycling profile. The user interface 901 can include a match score 902 corresponding to the cycling profile represented by the user interface 901. Similarly to the cycling profile shown in user interface 801, user interface 901 can include ride characteristics 904 of the user, such as a roach characteristic 906a. The user interface 901 can include one or more tags 908 associated with the user, such as weekend warrior 910n that represents a cycling behavior/characteristic of the user. The user interface 901 can include tabs 912 of time periods 914a-914d of cycling statistics 916 associated with the cycling profile. The user interface 901 illustrates that the time period 914c can be selected. The time period 914c can represent the cycling statistics 916 of the user in the past month. The cycling statistics 916 can include number of rides 918a, total ride time 918b, total elevation climbed 918c, total distance 918d, average intensity 918e, average speed 918f, average ride size 918g, and props 918h.

In particular embodiments, the cycling data platform 160 can calculate a match score 902 based on one or more parameters. The match score 902 can be calculated with respect to the user to other users (e.g., other riders), circles (e.g., communities or collections of users), group rides, routes, content and the like. As an example and not by way of limitation, each user, circle, group ride, route, or content may be associated with one or more tags, characteristics, and the like. The cycling data platform 160 can calculate the match score 902 by comparing how many similar tags there are between two separate entities (e.g., users, circles, group rides, routes, content, etc.). As an example and not by way of limitation, if a user is associated with tags/characteristics including road, gravel, group, weekend warrior, average speed of 22 mph, climber, average distance of 30 miles and another user is associated with the tags/characteristics including road, gravel, group, weekend warrior, average speed of 24 mph, climber, average distance of 26 miles, then the cycling data platform can calculate a match score of 92%. There may be different weights applied to each tag/characteristic of two separate entities as the cycling data platform 160 is calculating the match score 902 between the two entities. In particular embodiments, the match score 902 may be used to send recommendations to the user. As an example and not by way of limitation, the recommendations can include other users to connect with, circles to join, group rides to participate, routes to take, and content to watch. The cycling data platform 160 can determine a threshold match score 902 for each individual entity to recommend to the user. As an example and not by way of limitation, routes may need a lesser match score 902 to be recommended whereas another user would need a higher match score 902 to be recommended.

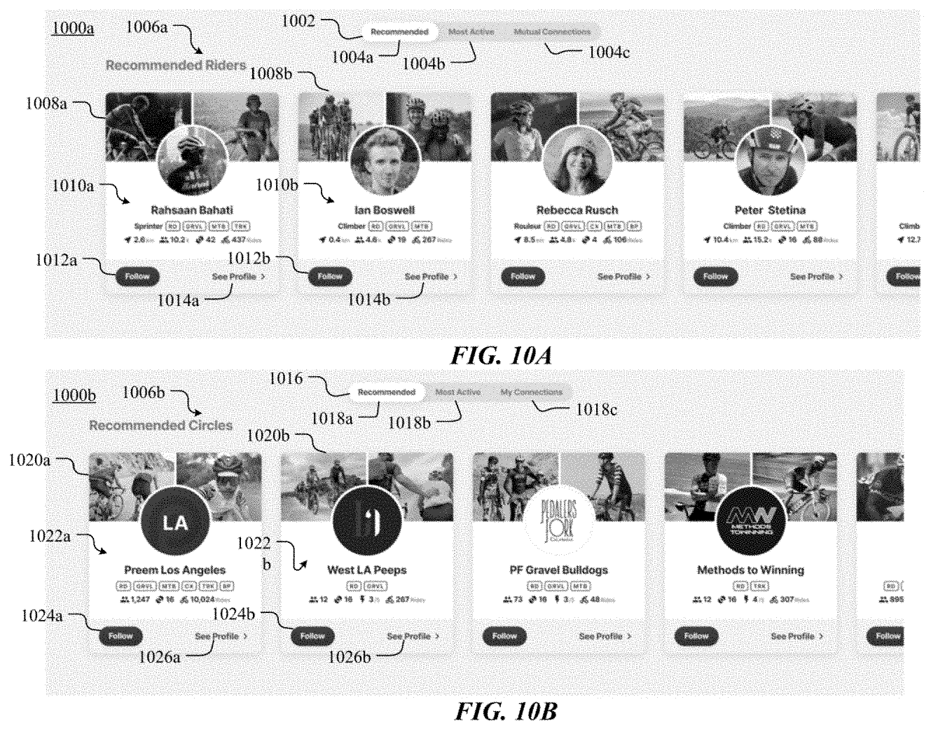

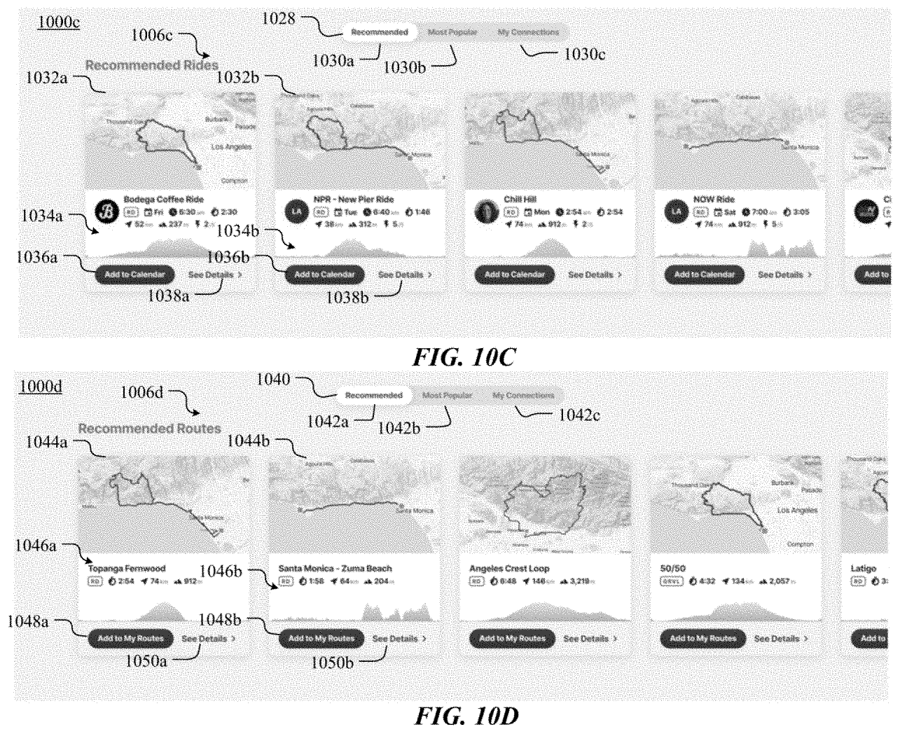

FIGS. 10A-10D illustrate example user interfaces of recommendations for a user. Referring to FIG. 10A, a user interface 1000a provided by a cycling data platform 160 is shown. In particular embodiments, the user interface 1000a can be a user interface of a cycling application 134 installed on a client system 130. The user interface 1000a can represent a user interface that recommends one or more riders that the user may be interested in connecting to. The user interface 1000a can include one or more tabs 1002, such as recommended 1004a, most active 1004b, and mutual connections 1004c. The user interface 1000a can represent the tab 1004a, which is a list of recommended riders 1006a for the user to connect with. The list of recommended riders 1006a can include one or more riders 1008, such as rider 1008a, 1008b. Each recommended rider 1008 can include a profile description 1010, an activatable element 1012, and an activatable element 1014. The activatable element 1012 can be selected to follow the respective cycling profile associated with the recommended rider 1008. The activatable element 1014 can be selected to view a cycling profile associated with the recommended rider 1008.

Referring to FIG. 10B, a user interface 1000b provided by a cycling data platform 160 is shown. In particular embodiments, the user interface 1000b can be a user interface of a cycling application 134 installed on a client system 130. The user interface 1000b can represent a user interface that recommends one or more circles or groups that the user may be interested in connecting to. The user interface 1000b can include one or more tabs 1016, such as recommended 1018a, most active 1018b, and my connections 1018c. The user interface 1000b can represent the tab 1018a, which is a list of recommended circles 1006b for the user to connect with. The list of recommended circles 1006b can include one or more circles 1020, such as circles 1020a, 1020b. Each recommended circle 1020 can include a profile description 1022, an activatable element 1024, and an activatable element 1026. The activatable element 1024 can be selected to follow the respective cycling profile associated with the recommended circle 1020. The activatable element 1014 can be selected to view a cycling profile associated with the recommended circle 1020.

Referring to FIG. 10C, a user interface 1000c provided by a cycling data platform 160 is shown. In particular embodiments, the user interface 1000c can be a user interface of a cycling application 134 installed on a client system 130. The user interface 1000c can represent a user interface that recommends one or more rides that the user may be interested in adding to his or her calendar. The user interface 1000c can include one or more tabs 1028, such as recommended 1030a, most popular 1030b, and my connections 1030c. The user interface 1000c can represent the tab 1030a, which is a list of recommended rides 1006c for the user to add to his or her calendar. The list of recommended rides 1006c can include one or more rides 1032, such as rides 1032a, 1032b. Each recommended ride 1032 can include a description 1034, an activatable element 1036, and an activatable element 1038. The activatable element 1036 can be selected to add the respective ride 1032 to the user's calendar. The activatable element 1038 can be selected to view further details associated with the recommended ride 1032. The recommended ride 1032 can present a map representation of the ride associated with the recommended ride 1032. Details such as associated group, number of people going on the ride, elevation change, weather, distance, and the like can be provided with the recommended ride 1032. In particular embodiments, a ride can represent an entity that includes a cycling route as well as details, such as participants and groups associated with the ride. The recommended rides can be determined using the recommendation engine of the cycling data platform 160. The recommendation engine can identify characteristics of cycling habits of the user, such as the average speed of the user to identify recommended rides. As an example and not by way of limitation, if the user likes to ride at an average of 22 mph, then the cycling data platform can identify a ride that includes other riders that also ride at an average of 22 mph on similar terrain and similar weather conditions.

Referring to FIG. 10D, a user interface 1000d provided by a cycling data platform 160 is shown. In particular embodiments, the user interface 1000d can be a user interface of a cycling application 134 installed on a client system 130. The user interface 1000d can represent a user interface that recommends one or more routes that the user may be interested in adding to his or her routes. The user interface 1000d can include one or more tabs 1040, such as recommended 1042a, most popular 1042b, and my connections 1042c. The user interface 1000d can represent the tab 1042a, which is a list of recommended routes 1006d for the user to add to his or her routes. The list of recommended routes 1006d can include one or more routes 1044, such as routes 1044a, 1044b. Each recommended route 1044 can include a description 1046, an activatable element 1048, and an activatable element 1050. The activatable element 1048 can be selected to add the respective route 1044 to the user's routes. The activatable element 1050 can be selected to view further details associated with the recommended route 1044. The recommended route 1044 can present a map representation of the route associated with the recommended route 1044. Details such as elevation change, weather, distance, and the like can be provided with the recommended route 1044.

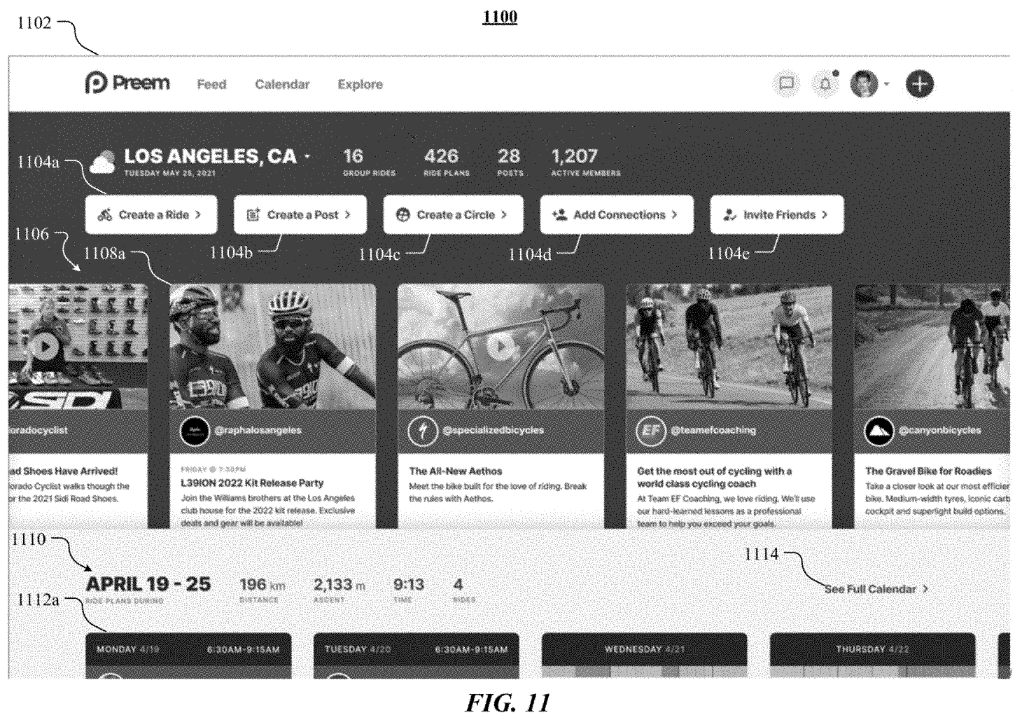

FIG. 11 illustrates an example user interface 1102 of a home screen associated with a cycling data platform 160. In particular embodiments, the user interface 1102 can be a user interface of a cycling application 134 installed on a client system 130. The user may access the user interface 1102 through one or more web portals associated with a cycling data platform 160. The user interface 1102 can include one or more activatable elements 1104a-1104e. The activatable element 1104a can be selected by the user to create a ride. The activatable element 1104b can be selected by the user to create a post associated with the cycling data platform 160.

The activatable element 1104c can be selected by the user to create a circle or group associated with the cycling data platform 160. The activatable element 1104d can be selected by the user add a connection associated with the cycling data platform 160. The activatable element 1104e can be selected by the user to invite one or more friends to the cycling data platform 160. The user interface 1102 can include content 1106 shown to the user, such as video 1108a. The content 1106 can include recommended content as described herein. As an example and not by way of limitation, the cycling data platform 160 can identify one or more tags associated with the user and recommend content that have the same or similar tags. The user interface 1102 can include ride plan 1110 of the upcoming week. The ride plan 1110 can include rides 1112 for each day, such as Monday ride plan 1112a. The user interface 1102 can include an activatable element 1114 to view a full calendar of the user, such as a calendar of the rides scheduled for the upcoming month.

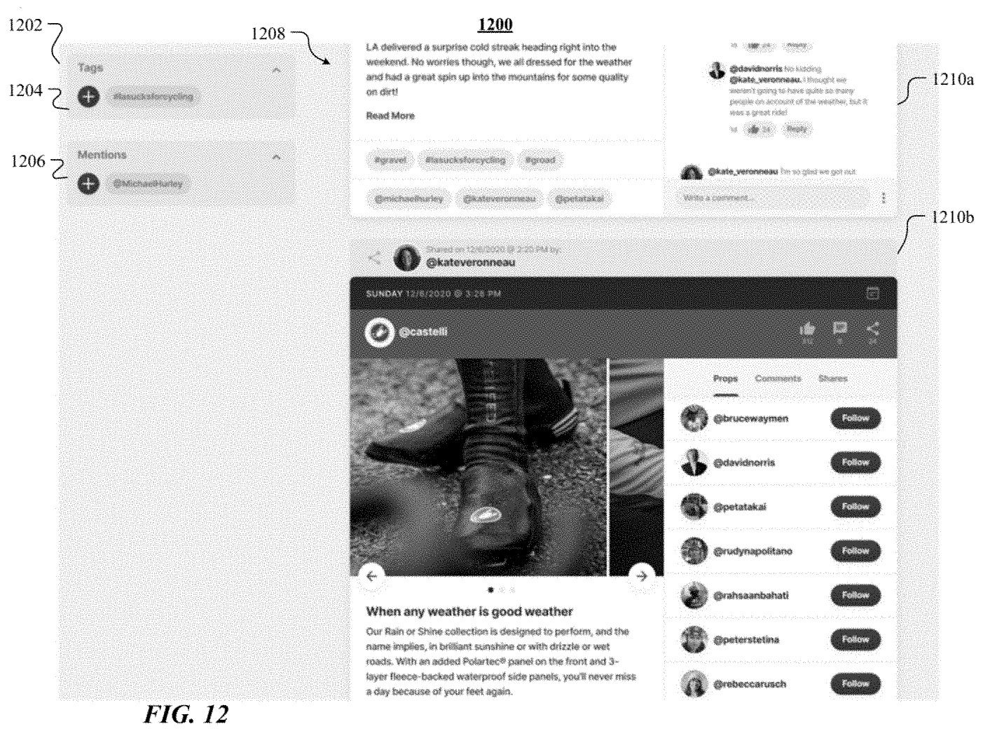

FIG. 12 illustrates an example user interface 1202 of a newsfeed 1208 associated with a cycling data platform 160. The user interface 1202 can include one or more tags 1204 associated with the newsfeed 1208 and one or more mentions 1206 associated with the newsfeed 1208. The newsfeed 1208 can be populated by one or more content 1210, such as post 1210a, 1210b. As described herein, the content 1210 can be identified based on the recommendations engine using one or more of a machine-learning model, a simple rules engine, or a matching engine.

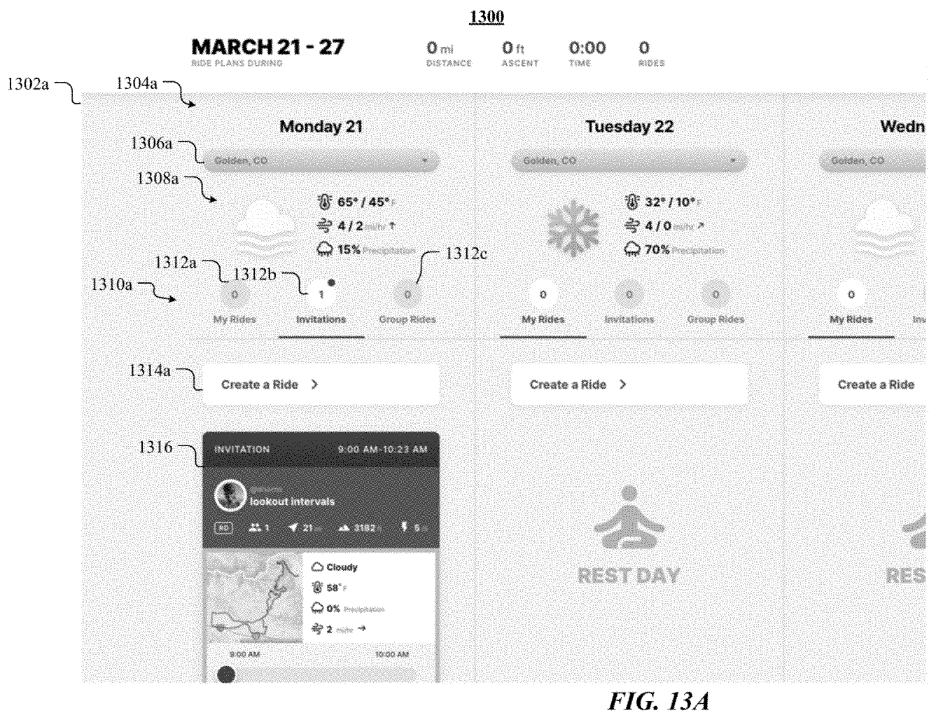

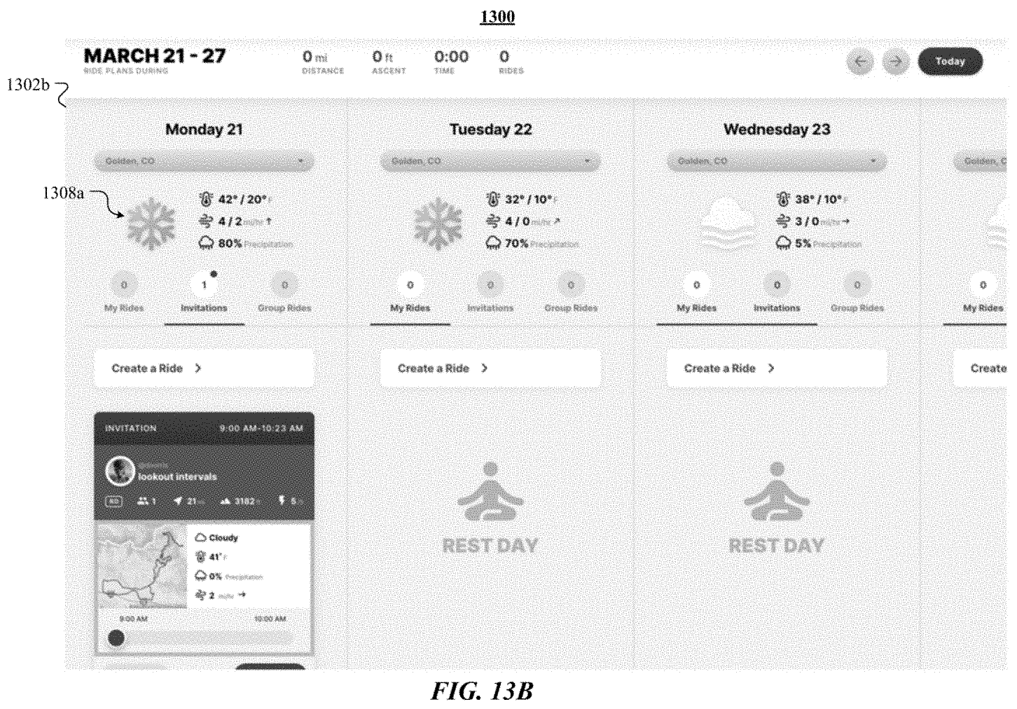

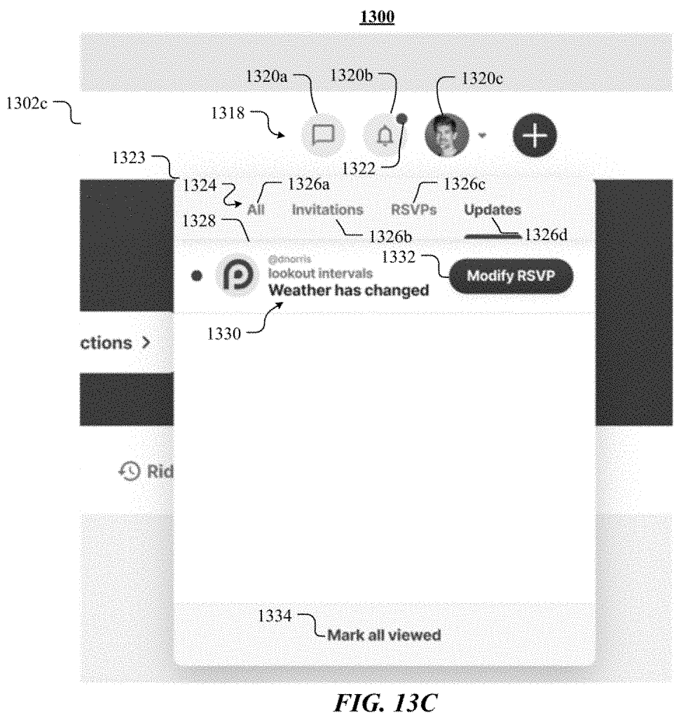

FIGS. 13A-13C illustrate example user interfaces of weather recommendations associated with a cycling data platform. Referring to FIG. 13A, a user interface 1302a of a website environment 1300 provided by a cycling data platform 160 is shown. In particular embodiments, the user interface 1302a can be a user interface of a cycling application 134 installed on a client system 130. The user interface 1302a can represent a ride plan for the upcoming week. The user interface 1302a can include a ride plan 1304 for each day of the week, such as Monday ride plan 1304a. The Monday ride plan 1304a can include a location 1306a, weather 1308a, list of rides 1310a including the user's rides 1312a, ride invitations 1312b, group rides 1312c, an activatable element 1314a, and a ride 1316. The activatable element 1314a can be selected to create a ride for the Monday ride plan 1304a. The ride 1316 can represent the ride details corresponding to the ride invitations 1312b. Referring to FIG. 13B, the user interface 1302b can represent the same user interface 1302a except with an updated weather information 1308. As an example and not by way of limitation, there may be a change in weather forecast for the upcoming day and the updated information may be sent to the cycling data platform 160.

Referring to FIG. 13C, a user interface 1302c of a website environment 1300 provided by a cycling data platform 160 is shown. In particular embodiments, the user interface 1302c can be a user interface of a cycling application 134 installed on a client system 130. The user interface 1302c can represent a notifications tab of a cycling profile. The user interface 1302c can include a list of activatable elements 1318 including activatable elements 1320a-1320c. The activatable element 1320a can be selected to view one or more messages associated with the cycling profile of the user. The activatable element 1320b can be selected to view one or more notifications associated with the cycling profile of the user. The activatable element 1320c can be selected to view a cycling profile of the user. The user interface 1302c can include an indicator 1322 representing there are one or more new notifications to be viewed. In response to the user selecting activatable element 1320b, the notifications tab 1323 can be shown. The notifications tab 1323 can include a list of filters 1324, such as all notifications 1326a, invitation notifications 1326b, RSVP notifications 1326c, update notifications 1326d, notification 1328, and activatable element 1334. The update notifications 1326d can be selected where the notification 1328 is displayed. The notification 1328 can include details 1330 and an activatable element 1332. The details 1330 can indicate that the cycling data platform 160 detected the weather has changed as illustrated between FIGS. 13A-13B. The activatable element 1332 can be selected to modify RSVP details for the corresponding ride. As an example and not by way of limitation, if the user previously RSVPed to join the ride, but is reconsidering due to the weather change, then the user can update the RSVP information to cancel. The activatable element 1334 can be selected to mark all of the notifications as viewed.

In particular embodiments, the details 1330 can inform a user of anticipated or actual weather conditions along a route. The details 1330 can recommend a user plan for a route or alternate activity type to which the conditions are better. The details 1330 can recommend a user to wear or buy certain clothing to prepare the user for a condition. As an example and not by way of limitation, the details 1330 can indicate the user bring a light jacket for colder weather. The details 1330 can recommend a user to plan their ride for a different day for a scenario where the ride will be unsatisfactory in comparison to what the user typically rides. As an example and not by way of limitation, the cycling data platform 160 can have data indicating the user never rides when it is snowing and determine that a ride will include snowy weather and as such recommend the user to reschedule the ride to another day. The details can include notifications to indicate that weather anticipated along a route which the user is currently riding may become adverse or potentially hazardous. As an example and not by way of limitation, the cycling data platform 160 can receive data indicative of flash flooding conditions several miles ahead along the route and recommend a different route for the user to follow.

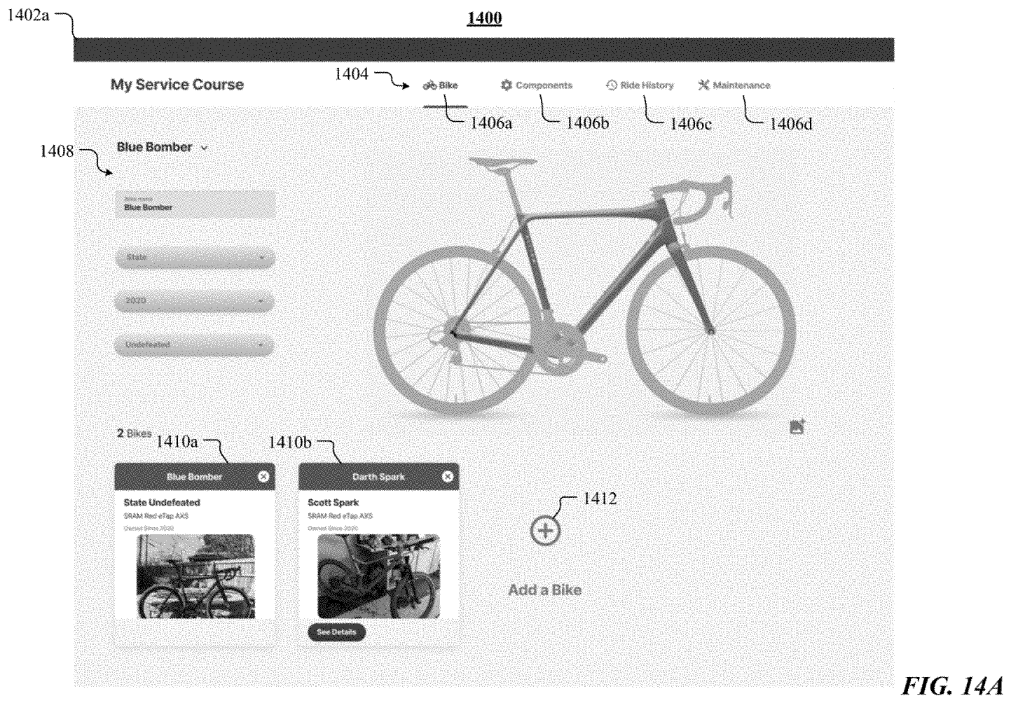

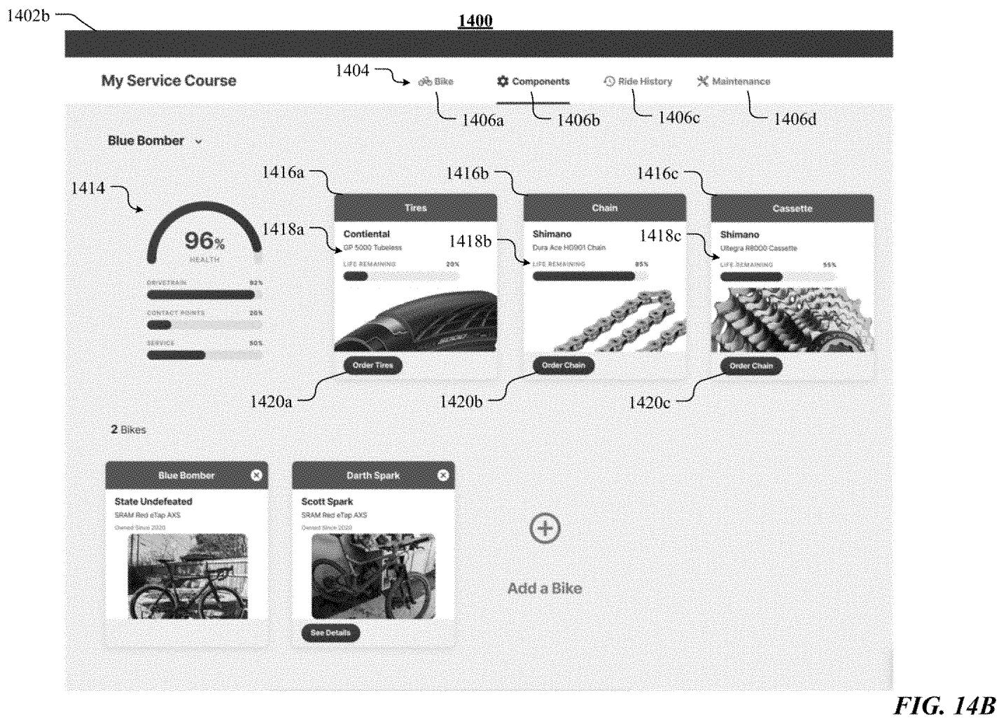

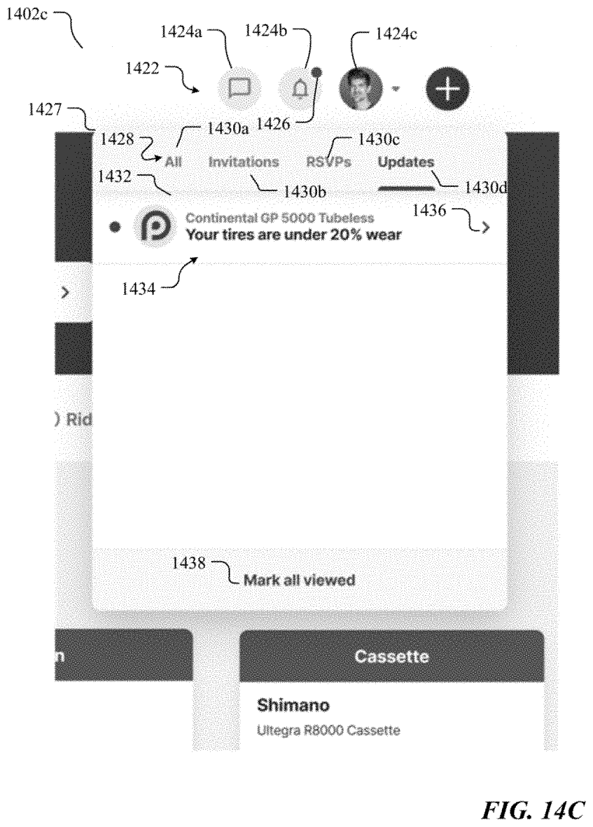

FIGS. 14A-14C illustrate example user interfaces of consumable recommendations associated with a cycling data platform. Referring to FIG. 14A, a user interface 1402a of a website environment 1400 provided by a cycling data platform 160 is shown. In particular embodiments, the user interface 1402a can be a user interface of a cycling application 134 installed on a client system 130. The user interface 1402a can be a user interface of a handling service of one or more bikes associated with the cycling profile. The user interface 1402a can include one or more tabs 1404, such as a bike tab 1406a, a components tab 1406b, a ride history tab 1406c, and a maintenance tab 1406d. The user interface 1402a can represent the user interface of the bike tab 1406a. The user interface 1402a can include bike details 1408, activatable elements 1410a-1410b, and an activatable element 1412. The activatable elements 1410a-1410b can be selected to populate the user interface 1402a with bike details corresponding to the selected activatable element 1410. The activatable element 1412 can be selected to add another bike to the cycling profile.

Referring to FIG. 14B, a user interface 1402b of a website environment 1400 provided by a cycling data platform 160 is shown. In particular embodiments, the user interface 1402b can be a user interface of a cycling application 134 installed on a client system 130. In response to the user selecting tab 1406b, the user interface 1402a can transition to user interface 1402b as shown in FIG. 14B. The components tab 1406b can include a calculated bike health score 1414. In particular embodiments, the cycling data platform 160 can calculate the bike health score 1414 based on one or more factors including a score for drivetrain, a score for contact points, and a score for service. Although only these factors are discussed in calculating a bike health score 1414, this disclosure contemplates calculating a bike health score 1414 using any number of factors in any suitable manner. The cycling data platform 160 can apply one or more weights to each of the factors to calculate the bike health score 1414. The user interface 1402b can include components 1416a-1416c of the selected bike from the previous user interface 1402a (e.g., “Blue Bomber”). Each component 1416a-1416c can include details 1418a-1418c, respectively, and a corresponding activatable element 1420a-1420c. The details 1418 can indicate the brand of the respective component 1416 and a calculated life remaining score based on a machine-learning model applied to data corresponding to the component 1416. As an example, the machine-learning model can calculate a life remaining score based on ride data associated with the rides the component 1416 has experienced. The route characteristics of the rides can be a factor to calculating the life remaining score. As an example and not by way of limitation, the machine-learning model may be able to accordingly reflect the wear riding on gravel has on a tire as opposed to riding on an asphalt road. The activatable element 1420 can be used to order more of the respective component 1416. As an example and not by way of limitation, if a user selects activatable element 1420a, the user can order more continental tires.

Referring to FIG. 14C, a user interface 1402c of a website environment 1400 provided by a cycling data platform 160 is shown. In particular embodiments, the user interface 1402c can be a user interface of a cycling application 134 installed on a client system 130. The user interface 1402c can represent a notifications tab of a cycling profile. The user interface 1402c can include a list of activatable elements 1422 including activatable elements 1424a-1424c. The activatable element 1424a can be selected to view one or more messages associated with the cycling profile of the user. The activatable element 1424b can be selected to view one or more notifications associated with the cycling profile of the user. The activatable element 1424c can be selected to view a cycling profile of the user. The user interface 1402c can include an indicator 1322 representing there are one or more new notifications to be viewed. In response to the user selecting activatable element 1424b, the notifications tab 1427 can be shown. The notifications tab 1427 can include a list of filters 1428, such as all notifications 1430a, invitation notifications 1430b, RSVP notifications 1430c, update notifications 1430d, notification 1432, and activatable element 1438. The update notifications 1430d can be selected where the notification 1432 is displayed. The notification 1432 can include details 1434 and an activatable element 1436. The details 1434 can indicate that the cycling data platform 160 detected that after a recent ride, the life remaining score of a component 1416 falls below a threshold life remaining score. The threshold life remaining score can be determined based on frequency of use of the corresponding bike among other factors. The activatable element 1436 can be selected to proceed to purchase the respective component. As an example and not by way of limitation, the activatable element 1436 can include a link to a website to purchase the respective component. The activatable element 1438 can be selected to mark all notifications as viewed.

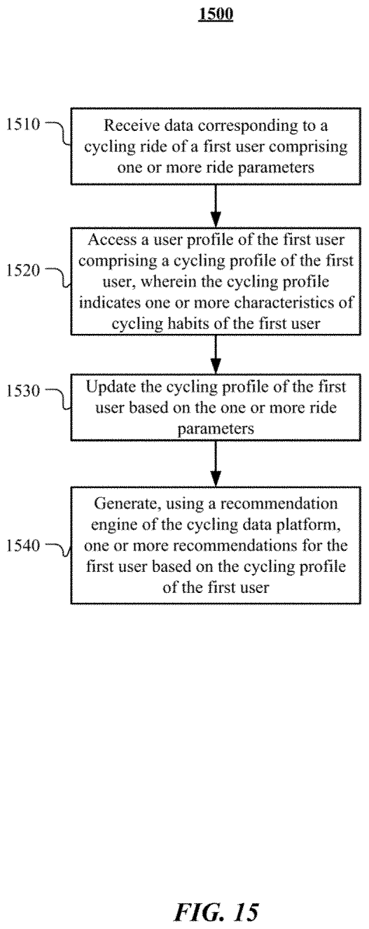

FIG. 15 illustrates an example method 1500 for generating a recommendation associated with a cycling data platform. The method 1500 may begin at step 1510, where a cycling data platform may receive data corresponding to a cycling ride of a first user comprising one or more ride parameters. At step 1520, the cycling data platform may access a user profile of the first user comprising a cycling profile of the first user. In particular embodiments, the cycling profile may indicate one or more characteristics of cycling habits of the first user. At step 1530, the cycling data platform may update the cycling profile of the first user based on the one or more ride parameters. At step 1540, the cycling data platform may generate, using a recommendation engine of the cycling data platform, one or more recommendations for the first user based on the cycling profile of the first user. Particular embodiments may repeat one or more steps of the method of FIG. 15, where appropriate. Although this disclosure describes and illustrates particular steps of the method of FIG. 15 as occurring in a particular order, this disclosure contemplates any suitable steps of the method of FIG. 15 occurring in any suitable order. Moreover, although this disclosure describes and illustrates an example method for generating a recommendation associated with a cycling data platform, including the particular steps of the method of FIG. 15, this disclosure contemplates any suitable method of generating a recommendation associated with a cycling data platform, including any suitable steps, which may include all, some, or none of the steps of the method of FIG. 15, where appropriate. Furthermore, although this disclosure describes and illustrates particular components, devices, or systems carrying out particular steps of the method of FIG. 15, this disclosure contemplates any suitable combination of any suitable components, devices, or systems carrying out any suitable steps of the method of FIG. 15.

### Systems and Methods

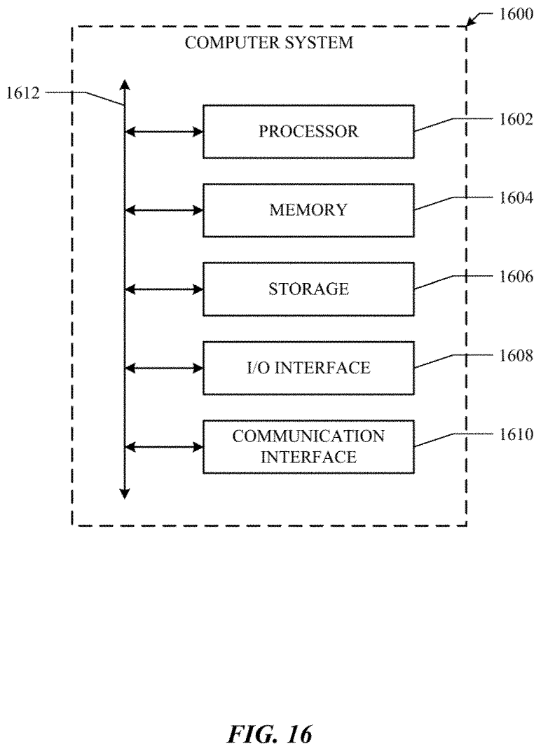

FIG. 16 illustrates an example computer system 1600. In particular embodiments, one or more computer systems 1600 perform one or more steps of one or more methods described or illustrated herein. In particular embodiments, one or more computer systems 1600 provide functionality described or illustrated herein. In particular embodiments, software running on one or more computer systems 1600 performs one or more steps of one or more methods described or illustrated herein or provides functionality described or illustrated herein. Particular embodiments include one or more portions of one or more computer systems 1600. Herein, reference to a computer system may encompass a computing device, and vice versa, where appropriate. Moreover, reference to a computer system may encompass one or more computer systems, where appropriate.

This disclosure contemplates any suitable number of computer systems 1600. This disclosure contemplates computer system 1600 taking any suitable physical form. As example and not by way of limitation, computer system 1600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1600 may include one or more computer systems 1600; be unitary or distributed; span multiple locations; span multiple machines; span multiple data centers; or reside in a cloud, which may include one or more cloud components in one or more networks. Where appropriate, one or more computer systems 1600 may perform without substantial spatial or temporal limitation one or more steps of one or more methods described or illustrated herein. As an example and not by way of limitation, one or more computer systems 1600 may perform in real time or in batch mode one or more steps of one or more methods described or illustrated herein. One or more computer systems 1600 may perform at different times or at different locations one or more steps of one or more methods described or illustrated herein, where appropriate.

In particular embodiments, computer system 1600 includes a processor 1602, memory 1604, storage 1606, an input/output (I/O) interface 1608, a communication interface 1610, and a bus 1612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1602 includes hardware for executing instructions, such as those making up a computer program. As an example and not by way of limitation, to execute instructions, processor 1602 may retrieve (or fetch) the instructions from an internal register, an internal cache, memory 1604, or storage 1606; decode and execute them; and then write one or more results to an internal register, an internal cache, memory 1604, or storage 1606. In particular embodiments, processor 1602 may include one or more internal caches for data, instructions, or addresses. This disclosure contemplates processor 1602 including any suitable number of any suitable internal caches, where appropriate. As an example and not by way of limitation, processor 1602 may include one or more instruction caches, one or more data caches, and one or more translation lookaside buffers (TLBs). Instructions in the instruction caches may be copies of instructions in memory 1604 or storage 1606, and the instruction caches may speed up retrieval of those instructions by processor 1602. Data in the data caches may be copies of data in memory 1604 or storage 1606 for instructions executing at processor 1602 to operate on; the results of previous instructions executed at processor 1602 for access by subsequent instructions executing at processor 1602 or for writing to memory 1604 or storage 1606; or other suitable data. The data caches may speed up read or write operations by processor 1602. The TLBs may speed up virtual-address translation for processor 1602. In particular embodiments, processor 1602 may include one or more internal registers for data, instructions, or addresses. This disclosure contemplates processor 1602 including any suitable number of any suitable internal registers, where appropriate. Where appropriate, processor 1602 may include one or more arithmetic logic units (ALUs); be a multi-core processor; or include one or more processors 1602. Although this disclosure describes and illustrates a particular processor, this disclosure contemplates any suitable processor.

In particular embodiments, memory 1604 includes main memory for storing instructions for processor 1602 to execute or data for processor 1602 to operate on. As an example and not by way of limitation, computer system 1600 may load instructions from storage 1606 or another source (such as, for example, another computer system 1600) to memory 1604. Processor 1602 may then load the instructions from memory 1604 to an internal register or internal cache. To execute the instructions, processor 1602 may retrieve the instructions from the internal register or internal cache and decode them. During or after execution of the instructions, processor 1602 may write one or more results (which may be intermediate or final results) to the internal register or internal cache. Processor 1602 may then write one or more of those results to memory 1604. In particular embodiments, processor 1602 executes only instructions in one or more internal registers or internal caches or in memory 1604 (as opposed to storage 1606 or elsewhere) and operates only on data in one or more internal registers or internal caches or in memory 1604 (as opposed to storage 1606 or elsewhere). One or more memory buses (which may each include an address bus and a data bus) may couple processor 1602 to memory 1604. Bus 1612 may include one or more memory buses, as described below. In particular embodiments, one or more memory management units (MMUs) reside between processor 1602 and memory 1604 and facilitate accesses to memory 1604 requested by processor 1602. In particular embodiments, memory 1604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1604 may include one or more memories 1604, where appropriate. Although this disclosure describes and illustrates particular memory, this disclosure contemplates any suitable memory.

In particular embodiments, storage 1606 includes mass storage for data or instructions. As an example and not by way of limitation, storage 1606 may include a hard disk drive (HDD), a floppy disk drive, flash memory, an optical disc, a magneto-optical disc, magnetic tape, or a Universal Serial Bus (USB) drive or a combination of two or more of these. Storage 1606 may include removable or non-removable (or fixed) media, where appropriate. Storage 1606 may be internal or external to computer system 1600, where appropriate. In particular embodiments, storage 1606 is non-volatile, solid-state memory. In particular embodiments, storage 1606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1606 taking any suitable physical form. Storage 1606 may include one or more storage control units facilitating communication between processor 1602 and storage 1606, where appropriate. Where appropriate, storage 1606 may include one or more storages 1606. Although this disclosure describes and illustrates particular storage, this disclosure contemplates any suitable storage.

In particular embodiments, I/O interface 1608 includes hardware, software, or both, providing one or more interfaces for communication between computer system 1600 and one or more I/O devices. Computer system 1600 may include one or more of these I/O devices, where appropriate. One or more of these I/O devices may enable communication between a person and computer system 1600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1608 for them. Where appropriate, I/O interface 1608 may include one or more device or software drivers enabling processor 1602 to drive one or more of these I/O devices. I/O interface 1608 may include one or more I/O interfaces 1608, where appropriate. Although this disclosure describes and illustrates a particular I/O interface, this disclosure contemplates any suitable I/O interface.

In particular embodiments, communication interface 1610 includes hardware, software, or both providing one or more interfaces for communication (such as, for example, packet-based communication) between computer system 1600 and one or more other computer systems 1600 or one or more networks. As an example and not by way of limitation, communication interface 1610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1610 for it. As an example and not by way of limitation, computer system 1600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1600 may include any suitable communication interface 1610 for any of these networks, where appropriate. Communication interface 1610 may include one or more communication interfaces 1610, where appropriate. Although this disclosure describes and illustrates a particular communication interface, this disclosure contemplates any suitable communication interface.

In particular embodiments, bus 1612 includes hardware, software, or both coupling components of computer system 1600 to each other. As an example and not by way of limitation, bus 1612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1612 may include one or more buses 1612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 1602 (such as, for example, one or more internal registers or caches), one or more portions of memory 1604, one or more portions of storage 1606, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), JavaScript Object Notation (JSON) or other suitable markup language.

### Privacy

In particular embodiments, one or more of the data objects of the cycling data platform may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the cycling data platform. Where the privacy settings for an object allow a particular component to access that object, the object may be described as being “visible” with respect to that component.

In particular embodiments, privacy settings may allow users to opt in or opt out of having their data logged by cycling data platform 160 or shared with other systems (e.g., third-party system 170). In particular embodiments, the privacy settings associated with an object may specify any suitable granularity of permitted access or denial of access. As an example and not by way of limitation, access or denial of access may be specified for particular components, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a component (or other entity) for a particular object stored in a data store 164, matching-engine system 160 may send a request to the data store 164 for the object. The request may identify the user associated with the request and may only be sent to the component if the authorization server determines that the component is authorized to access the object based on the privacy settings associated with the object. If the requesting component is not authorized to access the object, the authorization server may prevent the requested object from being retrieved from the data store 164, or may prevent the requested object from be sent to the component. Although this disclosure describes enforcing privacy settings in a particular manner, this disclosure contemplates enforcing privacy settings in any suitable manner.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by a cycling data platform:
receiving data corresponding to a cycling ride of a first user comprising one or more ride parameters;
accessing a user profile of the first user comprising a cycling profile of the first user, wherein the cycling profile indicates one or more characteristics of cycling habits of the first user;
updating the cycling profile of the first user based on the one or more ride parameters; and
generating, using a recommendations engine of the cycling data platform, one or more recommendations for the first user based on the cycling profile of the first user.

2. The method of claim 1, further comprising:
generating a notification of the one or more recommendations to send to a client system of the first user; and
sending instructions to the client system of the first user to present the notification.

3. The method of claim 1, wherein the one or more recommendations comprise one or more of:
content to be viewed by the first user,
product for the first user to purchase,
a second user to make a connection,
a group to join, or
a route for the first user to ride.

4. The method of claim 1, wherein the cycling habits of the first user is indicative of one or more previous cycling routes taken by the first user.

5. The method of claim 1, wherein the data corresponding to the cycling ride is received from one or more of a monitoring device or a client system of the first user.

6. The method of claim 1, wherein the one or more ride parameters comprise one or more of route characteristics.

7. The method of claim 1, wherein the recommendations engine comprises one or more of a machine-learning model, simple rules engine, or a matching engine.

8. One or more computer-readable non-transitory storage media embodying software that is operable when executed to:
receive data corresponding to a cycling ride of a first user comprising one or more ride parameters;
access a user profile of the first user comprising a cycling profile of the first user, wherein the cycling profile indicates one or more characteristics of cycling habits of the first user;
update the cycling profile of the first user based on the one or more ride parameters; and
generate, using a recommendations engine of a cycling data platform, one or more recommendations for the first user based on the cycling profile of the first user.

9. The media of claim 8, wherein the software is further operable when executed to:
generate a notification of the one or more recommendations to send to a client system of the first user; and
send instructions to the client system of the first user to present the notification.

10. The media of claim 8, wherein the one or more recommendations comprise one or more of:
content to be viewed by the first user,
product for the first user to purchase,
a second user to make a connection,
a group to join, or
a route for the first user to ride.

11. The media of claim 8, wherein the cycling habits of the first user is indicative of one or more previous cycling routes taken by the first user.

12. The media of claim 8, wherein the data corresponding to the cycling ride is received from one or more of a monitoring device or a client system of the first user.

13. The media of claim 8, wherein the one or more ride parameters comprise one or more of route characteristics.

14. The media of claim 8, wherein the recommendations engine comprises one or more of a machine-learning model, simple rules engine, or a matching engine.

15. A system comprising:
one or more processors; and
one or more computer-readable non-transitory storage media coupled to one or more of the processors and comprising instructions operable when executed by one or more of the processors to cause the system to:
receive data corresponding to a cycling ride of a first user comprising one or more ride parameters;
access a user profile of the first user comprising a cycling profile of the first user, wherein the cycling profile indicates one or more characteristics of cycling habits of the first user;
update the cycling profile of the first user based on the one or more ride parameters; and
generate, using a recommendations engine of a cycling data platform, one or more recommendations for the first user based on the cycling profile of the first user.

16. The system of claim 15, wherein the one or more of the processors are further operable when executing the instructions to cause the system to:
generate a notification of the one or more recommendations to send to a client system of the first user; and
send instructions to the client system of the first user to present the notification.

17. The system of claim 15, wherein the one or more recommendations comprise one or more of:
content to be viewed by the first user,
product for the first user to purchase,
a second user to make a connection,
a group to join, or
a route for the first user to ride.

18. The system of claim 15, wherein the cycling habits of the first user is indicative of one or more previous cycling routes taken by the first user.

19. The system of claim 15, wherein the data corresponding to the cycling ride is received from one or more of a monitoring device or a client system of the first user.

20. The system of claim 15, wherein the one or more ride parameters comprise one or more of route characteristics.
